(19) United States
(12) Patent Application Publication
(10) Pub. No.: US 2026/0242150 A1
(43) Pub. Date: Aug. 20, 2026

(54) BRANCH TRANSPORT DEVICE, CONVEYOR TABLE TRANSPORT SYSTEM, AND CONVEYOR TABLE TRANSPORT METHOD

(71) Applicant: YAMAHA HATSUDOKI KABUSHIKI KAISHA, Iwata-shi, Shizuoka-ken (JP)

(72) Inventor: Kota YAMAGUCHI, Iwata-shi (JP)

(73) Assignee: YAMAHA HATSUDOKI KABUSHIKI KAISHA, Iwata-shi, Shizuoka-ken (JP)

(21) Appl. No.: 18/832,793

(22) PCT Filed: Feb. 25, 2022
(86) PCT No.: PCT/JP2022/007998

§ 371 Date: Jul. 24, 2024

(51) Int. Cl. B65G 37/00; B65G 54/02

(52) U.S. Cl. CPC B65G 37/005; B65G 54/02

(57) ABSTRACT

A branch transport device includes movable linear conveyors aligned in parallel in the X direction. It is possible to drive the movable linear conveyor in the Y direction by the first drive part independently of the movable linear conveyor and to drive the movable linear conveyor in the Y direction by the second drive part independently of the movable linear conveyor. Thus, in parallel with a period when the movable linear conveyor to which the conveyor table transferred from a linear conveyor that is a branch source moves to a move destination and then motion at the move destination is completed, for example, it is possible for the movable linear conveyor to conduct motion for another branch transport.

### CROSS-REFERENCE TO RELATED APPLICATION

This application is a National Stage of International Patent Application No. PCT/JP2022/007998, filed Feb. 25, 2022, the entire contents of which is incorporated herein by reference.

### BACKGROUND

### Technical Field

The present disclosure relates to a technique of transporting a conveyor table by a linear conveyor, particularly to a technique of branching a destination of transport of the conveyor table.

### Background Art

There is a known transport system in which a conveyor table engageable with and removable from a linear conveyor is transported by the linear conveyor. In this transport system, the conveyor table is transferred from an upstream-side linear conveyor to a downstream-side linear conveyor in a transport direction, thereby transporting the conveyor table by a plurality of the linear conveyors aligned in the transport direction. In the transport system for the conveyor table, branch transport such as the one described in U.S. Pat. No. 10,829,317 can be formed.

### SUMMARY

More specifically, a plurality of downstream linear conveyors are aligned in parallel relative to an upstream linear conveyor. A branch transport device is arranged between the upstream linear conveyor and the downstream linear conveyors. The branch transport device includes a movable linear conveyor. While the movable linear conveyor faces the upstream linear conveyor, a conveyor table is transferred from the upstream linear conveyor to the movable linear conveyor. The movable linear conveyor further moves to a position (move destination) facing one downstream linear conveyor of the plurality of downstream linear conveyors that is a branch destination, and the conveyor table is transferred from the movable linear conveyor to this downstream linear conveyor.

A move destination of the movable linear conveyor holding the conveyor table transferred from the upstream linear conveyor is not limited to the position facing the downstream linear conveyor but may also be a work area for conducting work on a workpiece placed on the conveyor table, for example. This allows implementation of the work on the workpiece placed on the conveyor table held by the movable linear conveyor in the work area.

The above-described branch transport device achieves branch transport of the conveyor table by switching a move destination of the movable linear conveyor (the position facing the downstream linear conveyor or the work area) as appropriate, the movable linear conveyor holding the conveyor table transferred from the upstream linear conveyor that is a branch source. Meanwhile, according to operation performed in conventional cases, after the movable linear conveyor, to which the conveyor table is transferred from the linear conveyor that is the branch source, moves to the move destination and then motion at the move destination (transfer of the conveyor table or implementation of work) is completed, the movable linear conveyor conducts motion for another branch transport. This leaves a room for improvement in terms of realizing efficient branch transport of the conveyor table.

The present disclosure has been made in view of the above-described problem, and is intended to enable efficient branch transport of a conveyor table.

A branch transport device according to the disclosure, comprises a first movable linear conveyor and a second movable linear conveyor aligned in parallel in a predetermined transport direction; and a drive mechanism including a first drive part configured to drive the first movable linear conveyor in a drive direction different from the transport direction and a second drive part configured to drive the second movable linear conveyor in the drive direction. Each of the first movable linear conveyor and the second movable linear conveyor transports a conveyor table in the transport direction.

A conveyor table transport method according to the disclosure, comprises: a step of driving a first movable linear conveyor of the first movable linear conveyor and a second movable linear conveyor, which are aligned in parallel in a predetermined transport direction and each of which transports a conveyor table in the transport direction, in a drive direction different from the transport direction by a first drive part; and a step of driving the second movable linear conveyor in the drive direction by the first drive part.

According to the present disclosure having the above-described configurations (branch transport device and conveyor table transport method), the first and second movable linear conveyors are provided that are aligned in parallel in the transport direction. The first drive part that drives the first movable linear conveyor in the drive direction and the second drive part that drives the second movable linear conveyor in the drive direction are further provided. This allows the first movable linear conveyor to be driven in the drive direction by the first drive part independently of the second movable linear conveyor and allows the second movable linear conveyor to be driven in the drive direction by the second drive part independently of the first movable linear conveyor. Thus, in parallel with a period when the first movable linear conveyor having received the conveyor table transferred from a linear conveyor as a branch source moves to a move destination and then motion at the move destination is completed, for example, it is possible for the second movable linear conveyor to conduct motion for another branch transport. In this way, it is possible to conduct efficient branch transport of the conveyor table.

The branch transport device may be configured so that the first drive part is mounted on the first movable linear conveyor and drives the first movable linear conveyor in the drive direction by moving in the drive direction, and the second drive part is mounted on the second movable linear conveyor and drives the second movable linear conveyor in the drive direction by moving in the drive direction. This configuration allows the first movable linear conveyor to be driven in the drive direction independently of the second movable linear conveyor by the first drive part mounted on the first movable linear conveyor, and allows the second movable linear conveyor to be driven in the drive direction independently of the first movable linear conveyor by the second drive part mounted on the second movable linear conveyor.

The branch transport device may be configured so that the drive mechanism further includes a screw shaft arranged parallel to the drive direction, the first drive part includes a first nut threadedly engaged with the screw shaft and a first motor to drive the first nut, and moves in the drive direction by rotating the first nut relative to the screw shaft by the first motor, and the second drive part includes a second nut threadedly engaged with the screw shaft and a second motor to drive the second nut, and moves in the drive direction by rotating the second nut relative to the screw shaft by the second motor. This configuration allows the first movable linear conveyor to be driven in the drive direction independently of the second movable linear conveyor by the first motor, and allows the second movable linear conveyor to be driven in the drive direction independently of the first movable linear conveyor by the second motor.

The branch transport device may be configured so that the drive mechanism further includes a stator formed from a permanent magnet arranged parallel to the drive direction, the first drive part includes a first mover formed from a coil and moves in the drive direction in response to magnetic force generated between the first mover and the stator, and the second drive part includes a second mover formed from a coil and moves in the drive direction in response to magnetic force generated between the second mover and the stator. This configuration allows the first movable linear conveyor to be driven in the drive direction independently of the second movable linear conveyor by the first mover, and allows the second movable linear conveyor to be driven in the drive direction independently of the first movable linear conveyor by the second mover.

The drive direction in which the first and second movable linear conveyors are driven can be assumed in various ways. For example, the transport direction and the drive direction may be orthogonal to each other.

By forming a conveyor table transport system using the above-described branch transport device, it becomes possible to conduct efficient branch transport of the conveyor table in this conveyor table transport system.

That is, a conveyor table transport system may be configured so as to comprise: the branch transport device described above; and a line linear conveyor. The first movable linear conveyor is positioned on a first side in the drive direction relative to the second movable linear conveyor, the second movable linear conveyor is positioned on a second side opposite the first side in the drive direction relative to the first movable linear conveyor, while the first drive part positions the first movable linear conveyor at a transport facing position facing the line linear conveyor in the transport direction. Also, a first conveyor table is transferred between the first movable linear conveyor and the line linear conveyor, and while the second drive part positions the second movable linear conveyor at the transport facing position, a second conveyor table is transferred between the second movable linear conveyor and the line linear conveyor. In this configuration, while the respective positions of the first movable linear conveyor and the second linear conveyor are controlled in the drive direction independently of each other, it is possible to transport the first conveyor table by the first movable linear conveyor and transport the second conveyor table by the second movable linear conveyor.

The conveyor table transport system may be configured so as to further comprise a first working unit arranged in a first work area on the first side in the drive direction relative to the transport facing position. In the first work area, first work is conducted on a first workpiece supported by the first conveyor table, the first drive part moves the first movable linear conveyor holding the first conveyor table to the first work area. Also, in the first work area, the first drive part moves the first movable linear conveyor in the drive direction and the first movable linear conveyor moves the first conveyor table in the transport direction, thereby causing the first working unit, the first drive part, and the first movable linear conveyor to conduct the first work in cooperation with each other. This configuration allows the first movable linear conveyor holding the first conveyor table to move to the first work area independently of the second movable linear conveyor. Furthermore, in the first work area, the first drive part and the first movable linear conveyor function together as an XY table to contribute to conduct of the first work.

The conveyor table transport system may be configured so as to further comprise a second working unit arranged in a second work area on the second side in the drive direction relative to the transport facing position. In the second work area, second work is conducted on a second workpiece supported by the second conveyor table, the second drive part moves the second movable linear conveyor holding the second conveyor table to the second work area, and in the second work area, the second drive part moves the second movable linear conveyor in the drive direction and the second movable linear conveyor moves the second conveyor table in the transport direction, thereby causing the second working unit, the second drive part, and the second movable linear conveyor to conduct the second work in cooperation with each other. This configuration allows the second movable linear conveyor holding the second conveyor table to move to the second work area independently of the first movable linear conveyor. Furthermore, in the second work area, the second drive part and the second movable linear conveyor function together as an XY table to contribute to conduct of the second work.

The conveyor table transport may be configured so that a period when the first work is conducted and a period when the second work is conducted overlap each other at least partially. In this configuration, the first work and the second work are conducted efficiently in parallel.

The conveyor table transport system may be configured so as to further comprise a first work linear conveyor facing a first work facing position arranged on the first side in the drive direction relative to the transport facing position, in the transport direction. The first drive part moves the first movable linear conveyor holding the first conveyor table to the first work facing position, the first conveyor table is transferred from the first movable linear conveyor positioned at the first work facing position to the first work linear conveyor, and first work is conducted on a first workpiece supported by the first conveyor table held by the first work linear conveyor. In this configuration, it is possible to move the first movable linear conveyor holding the first conveyor table to the first work facing position independently of the second movable linear conveyor and to transfer the first conveyor table from the first movable linear conveyor to the first work linear conveyor.

The conveyor table transport system may be configured so as to further comprise a second work linear conveyor facing a second work facing position arranged on the second side in the drive direction relative to the transport facing position, in the transport direction. The second drive part moves the second movable linear conveyor holding the second conveyor table to the second work facing position, the second conveyor table is transferred from the second movable linear conveyor positioned at the second work facing position to the second work linear conveyor, and second work is conducted on a second workpiece supported by the second conveyor table held by the second work linear conveyor. In this configuration, it is possible to move the second movable linear conveyor holding the second conveyor table to the second work facing position independently of the first movable linear conveyor and to transfer the second conveyor table from the second movable linear conveyor to the second work linear conveyor.

The conveyor table transport system may be configured so that a period when the first work is conducted and a period when the second work is conducted overlap each other at least partially. In this configuration, the first work and the second work are conducted efficiently in parallel.

A conveyor table transport system may be configured so as to comprise the branch transport device described above; and a work linear conveyor facing a work facing position between a workpiece introduction position and a workpiece ejection position arranged at an interval therebetween in the drive direction, in the transport direction. The first movable linear conveyor is positioned on the workpiece introduction position side rather than the second movable linear conveyor in the drive direction, the second movable linear conveyor is positioned on the workpiece ejection position side rather than the first movable linear conveyor in the drive direction. Also, when the first drive part positions the first movable linear conveyor at the workpiece introduction position, a workpiece is placed on one conveyor table held by the first movable linear conveyor. In addition, when the first drive part positions the first movable linear conveyor holding the one conveyor table on which the workpiece is placed, at the work facing position, the one conveyor table is transferred from the first movable linear conveyor to the work linear conveyor. Furthermore, when the second drive part positions the second movable linear conveyor at the work facing position, the one conveyor table on which the workpiece is placed is transferred from the work linear conveyor to the second movable linear conveyor, and when the second drive part positions the second movable linear conveyor at the workpiece ejection position, the workpiece is removed from the one conveyor table. In this configuration, introduction of the workpiece is conducted for the first movable linear conveyor and ejection of the workpiece is conducted for the second movable linear conveyor. In this way, of the first and second movable linear conveyors movable in the drive direction independently of each other, the first linear conveyor is used for introduction of the workpiece and the second linear conveyor is used for ejection of the workpiece. This allows introduction and ejection of the workpiece to be conducted independently of each other.

A conveyor table transport system may be configured so as to comprise the branch transport device described above; an upstream linear conveyor arranged on an upstream side in the transport direction from the branch transport device; and a first downstream linear conveyor and a second downstream linear conveyor aligned in parallel on a downstream side in the transport direction from the branch transport device. The first downstream linear conveyor is positioned on a first side in the drive direction relative to the second downstream linear conveyor, and the second downstream linear conveyor is positioned on a second side in the drive direction relative to the first downstream linear conveyor. Also, the first movable linear conveyor is positioned on the first side in the drive direction relative to the second movable linear conveyor, the second movable linear conveyor is positioned on the second side opposite the first side in the drive direction relative to the first movable linear conveyor, and the first drive part moves the first movable linear conveyor between an upstream facing position facing the upstream linear conveyor from the downstream side in the transport direction and a first downstream facing position facing the first downstream linear conveyor from the upstream side in the transport direction. In addition, the conveyor table is transferred from the upstream linear conveyor to the first movable linear conveyor positioned at the upstream facing position, and the conveyor table is transferred from the first movable linear conveyor positioned at the first downstream facing position to the first downstream linear conveyor. Furthermore, the second drive part moves the second movable linear conveyor between the upstream facing position and a second downstream facing position facing the second downstream linear conveyor from the upstream side in the transport direction. Also, the conveyor table is transferred from the upstream linear conveyor to the second movable linear conveyor positioned at the upstream facing position, and the conveyor table is transferred from the second movable linear conveyor positioned at the second downstream facing position to the second downstream linear conveyor. In addition, in the drive direction, an interval between the first downstream facing position and the upstream facing position and an interval between the second downstream facing position and the upstream facing position differ from each other. In this configuration, by utilizing the advantage that the first movable linear conveyor and the second movable linear conveyor are movable in the drive direction independently of each other, arranged are the first downstream linear conveyor, which is a destination of transport of the conveyor table by the first movable linear conveyor, and the second downstream linear conveyor, which is a destination of transport of the conveyor table by the second movable linear conveyor. Specifically, it is possible to locate each of the first and second downstream linear conveyors freely as a destination of transport of the conveyor table in response to an environment of installation of the conveyor table transport system.

A conveyor table transport system may be configured so as to comprise a first branch transport device and a second branch transport device arranged at an interval therebetween in the transport direction; and a plurality of work linear conveyors aligned in parallel in the transport direction between the first branch transport device and the second branch transport device. The first branch transport device and the second branch transport device each have a configuration same as that of the branch transport device described above, the conveyor table is transferred between the work linear conveyor facing the first movable linear conveyor of the first branch transport device and the first movable linear conveyor, and the first branch transport device drives the first movable linear conveyor in the drive direction by the first drive part, thereby switching the work linear conveyor to face the first movable linear conveyor. Also, the conveyor table is transferred between the work linear conveyor facing the second movable linear conveyor of the first branch transport device and the second movable linear conveyor, and the first branch transport device drives the second movable linear conveyor in the drive direction by the second drive part, thereby switching the work linear conveyor to face the second movable linear conveyor. In addition, the conveyor table is transferred between the work linear conveyor facing the first movable linear conveyor of the second branch transport device and the first movable linear conveyor, and the second branch transport device drives the first movable linear conveyor in the drive direction by the first drive part, thereby switching the work linear conveyor to face the first movable linear conveyor. Furthermore, the conveyor table is transferred between the work linear conveyor facing the second movable linear conveyor of the second branch transport device and the second movable linear conveyor, and the second branch transport device drives the second movable linear conveyor in the drive direction by the second drive part, thereby switching the work linear conveyor to face the second movable linear conveyor. In this configuration, it is possible to transport the conveyor table by moving the first and second movable linear conveyors of the branch transport device independently of each other in the drive direction on the opposite sides of the plurality of work linear conveyors arranged in parallel in the transport direction.

A conveyor table transport system may be configured so as to comprise a branch transport device including a first movable linear conveyor and a second movable linear conveyor aligned in parallel in a predetermined transport direction, and driving the first movable linear conveyor and the second movable linear conveyor in a drive direction different from the transport direction; an upstream linear conveyor arranged on an upstream side in the transport direction from the branch transport device; and a first downstream linear conveyor and a second downstream linear conveyor aligned in parallel on a downstream side in the transport direction from the branch transport device. The first downstream linear conveyor is positioned on a first side in the drive direction relative to the second downstream linear conveyor, and the second downstream linear conveyor is positioned on a second side in the drive direction relative to the first downstream linear conveyor. Also, the first movable linear conveyor is positioned on the first side in the drive direction relative to the second movable linear conveyor, and the second movable linear conveyor is positioned on the second side opposite the first side in the drive direction relative to the first movable linear conveyor. In addition, while causing the first movable linear conveyor to face the upstream linear conveyor in the transport direction and causing the second movable linear conveyor to face the second downstream linear conveyor in the transport direction, the branch transport device conducts transfer of a conveyor table from the upstream linear conveyor to the first movable linear conveyor and transfer of a conveyor table from the second movable linear conveyor to the second downstream linear conveyor in parallel. Furthermore, while causing the second movable linear conveyor to face the upstream linear conveyor in the transport direction and causing the first movable linear conveyor to face the first downstream linear conveyor in the transport direction, the branch transport device conducts transfer of a conveyor table from the upstream linear conveyor to the second movable linear conveyor and transfer of a conveyor table from the first movable linear conveyor to the first downstream linear conveyor in parallel.

A conveyor table transport method may be configured so as to transport a conveyor table using a branch transport device, an upstream linear conveyor, a first downstream linear conveyor and a second downstream linear conveyor, the branch transport device including a first movable linear conveyor and a second movable linear conveyor aligned in parallel in a predetermined transport direction, and driving the first movable linear conveyor and the second movable linear conveyor in a drive direction different from the transport direction. The upstream linear conveyor is arranged on an upstream side in the transport direction from the branch transport device. The first downstream linear conveyor and the second downstream linear conveyor are aligned in parallel on a downstream side in the transport direction from the branch transport device. Also, the first downstream linear conveyor is positioned on a first side in the drive direction relative to the second downstream linear conveyor, the second downstream linear conveyor is positioned on a second side in the drive direction relative to the first downstream linear conveyor, the first movable linear conveyor is positioned on the first side in the drive direction relative to the second movable linear conveyor, and the second movable linear conveyor is positioned on the second side opposite the first side in the drive direction relative to the first movable linear conveyor. In addition, while causing the first movable linear conveyor to face the upstream linear conveyor in the transport direction and causing the second movable linear conveyor to face the second downstream linear conveyor in the transport direction, the branch transport device conducts transfer of a conveyor table from the upstream linear conveyor to the first movable linear conveyor and transfer of a conveyor table from the second movable linear conveyor to the second downstream linear conveyor in parallel. Furthermore, while causing the second movable linear conveyor to face the upstream linear conveyor in the transport direction and causing the first movable linear conveyor to face the first downstream linear conveyor in the transport direction, the branch transport device conducts transfer of a conveyor table from the upstream linear conveyor to the second movable linear conveyor and transfer of a conveyor table from the first movable linear conveyor to the first downstream linear conveyor in parallel.

In the above-described configurations (conveyor table transport system and conveyor table transport method), transfer of the conveyor table from the upstream linear conveyor to the first movable linear conveyor and transfer of the conveyor table from the second movable linear conveyor to the second downstream linear conveyor in parallel. Furthermore, transfer of the conveyor table from the upstream linear conveyor to the second movable linear conveyor and transfer of the conveyor table from the first movable linear conveyor to the first downstream linear conveyor in parallel. In this way, the motions for branch transport conducted by the first and second movable linear conveyors are conducted in parallel. This achieves efficient branch transport of the conveyor table.

According to the present disclosure, it is possible to conduct efficient branch transport of a conveyor table.

### BRIEF DESCRIPTION OF THE DRAWINGS

FIG. 1A is a perspective view showing an example of a basic configuration of a linear conveyor;

FIG. 1B is a perspective view showing the linear conveyor in FIG. 1A with a partially exposed interior thereof;

FIG. 2A is a side view schematically showing a first example of an internal configuration of a branch transport device according to the present disclosure;

FIG. 2B is a side view schematically showing a second example of the internal configuration of the branch transport device according to the present disclosure;

FIG. 3A is a view schematically showing a first example of the conveyor table transport system according to the present disclosure;

FIG. 3B is a view schematically showing a first example of the conveyor table transport system according to the present disclosure;

FIG. 3C is a view schematically showing a first example of the conveyor table transport system according to the present disclosure;

FIG. 3D is a view schematically showing a first example of the conveyor table transport system according to the present disclosure;

FIG. 3E is a view schematically showing a first example of the conveyor table transport system according to the present disclosure;

FIG. 3F is a view schematically showing a first example of the conveyor table transport system according to the present disclosure;

FIG. 3G is a view schematically showing a first example of the conveyor table transport system according to the present disclosure;

FIG. 3H is a view schematically showing a first example of the conveyor table transport system according to the present disclosure;

FIG. 3I is a view schematically showing a first example of the conveyor table transport system according to the present disclosure;

FIG. 3J is a view schematically showing a first example of the conveyor table transport system according to the present disclosure;

FIG. 3K is a view schematically showing a first example of the conveyor table transport system according to the present disclosure;

FIG. 4A is a view schematically showing a second example of the conveyor table transport system according to the present disclosure;

FIG. 4B is a view schematically showing a second example of the conveyor table transport system according to the present disclosure;

FIG. 4C is a view schematically showing a second example of the conveyor table transport system according to the present disclosure;

FIG. 4D is a view schematically showing a second example of the conveyor table transport system according to the present disclosure;

FIG. 4E is a view schematically showing a second example of the conveyor table transport system according to the present disclosure;

FIG. 4F is a view schematically showing a second example of the conveyor table transport system according to the present disclosure;

FIG. 4G is a view schematically showing a second example of the conveyor table transport system according to the present disclosure;

FIG. 4H is a view schematically showing a second example of the conveyor table transport system according to the present disclosure;

FIG. 4I is a view schematically showing a second example of the conveyor table transport system according to the present disclosure;

FIG. 4J is a view schematically showing a second example of the conveyor table transport system according to the present disclosure;

FIG. 5A is a view schematically showing a third example of the conveyor table transport system according to the present disclosure;

FIG. 5B is a view schematically showing a third example of the conveyor table transport system according to the present disclosure;

FIG. 5C is a view schematically showing a third example of the conveyor table transport system according to the present disclosure;

FIG. 5D is a view schematically showing a third example of the conveyor table transport system according to the present disclosure;

FIG. 5E is a view schematically showing a third example of the conveyor table transport system according to the present disclosure;

FIG. 5F is a view schematically showing a third example of the conveyor table transport system according to the present disclosure;

FIG. 5G is a view schematically showing a third example of the conveyor table transport system according to the present disclosure;

FIG. 5H is a view schematically showing a third example of the conveyor table transport system according to the present disclosure;

FIG. 5I is a view schematically showing a third example of the conveyor table transport system according to the present disclosure;

FIG. 5J is a view schematically showing a third example of the conveyor table transport system according to the present disclosure;

FIG. 5K is a view schematically showing a third example of the conveyor table transport system according to the present disclosure;

FIG. 5L is a view schematically showing a third example of the conveyor table transport system according to the present disclosure;

FIG. 5M is a view schematically showing a third example of the conveyor table transport system according to the present disclosure;

FIG. 5N is a view schematically showing a third example of the conveyor table transport system according to the present disclosure;

FIG. 6A is a view schematically showing a fourth example of the conveyor table transport system according to the present disclosure;

FIG. 6B is a view schematically showing a fourth example of the conveyor table transport system according to the present disclosure;

FIG. 6C is a view schematically showing a fourth example of the conveyor table transport system according to the present disclosure;

FIG. 6D is a view schematically showing a fourth example of the conveyor table transport system according to the present disclosure;

FIG. 6E is a view schematically showing a fourth example of the conveyor table transport system according to the present disclosure;

FIG. 6F is a view schematically showing a fourth example of the conveyor table transport system according to the present disclosure;

FIG. 6G is a view schematically showing a fourth example of the conveyor table transport system according to the present disclosure;

FIG. 6H is a view schematically showing a fourth example of the conveyor table;

FIG. 7A is a view schematically showing exemplary motions according to the fourth example of the conveyor table transport system;

FIG. 7B is a view schematically showing exemplary motions according to the fourth example of the conveyor table transport system;

FIG. 8A is a view schematically showing a fifth example of the conveyor table transport system according to the present disclosure;

FIG. 8B is a view schematically showing a fifth example of the conveyor table transport system according to the present disclosure;

FIG. 9A is a view schematically showing a sixth example of the conveyor table transport system according to the present disclosure;

FIG. 9B is a view schematically showing a sixth example of the conveyor table transport system according to the present disclosure; and

FIG. 10 is a view schematically showing a seventh example of the conveyor table transport system according to the present disclosure;

### DETAILED DESCRIPTION

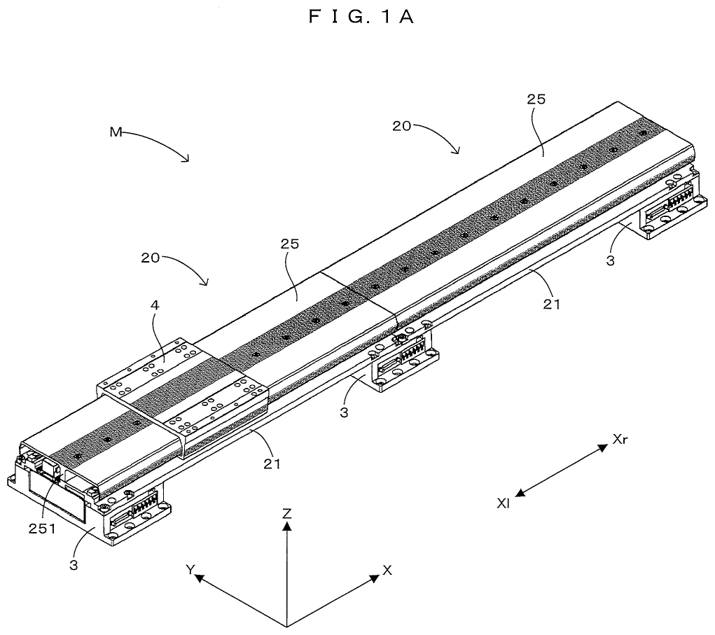

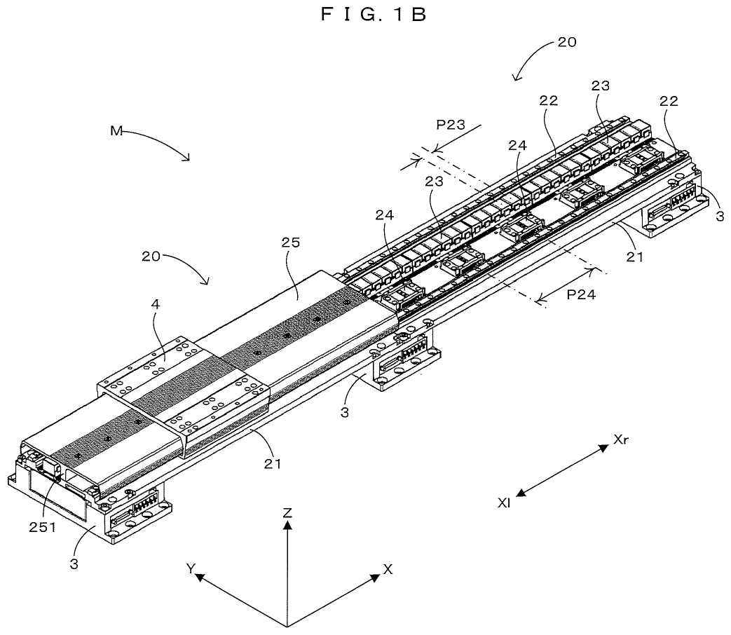

FIG. 1A is a perspective view showing an example of a basic configuration of a linear conveyor. FIG. 1B is a perspective view showing the linear conveyor in FIG. 1A with a partially exposed interior thereof. FIGS. 1A and 1B are drawn with XYZ orthogonal coordinate axes having an X direction parallel to a horizontal direction, a Y direction orthogonal to the X direction and parallel to the horizontal direction, and a Z direction parallel to a vertical direction. Furthermore, a diagonal upper right side in the X direction in each of the drawings is expressed as an Xr side and a diagonal lower left side in the X direction in each of the drawings is expressed as an Xl side. These expressions are used as appropriate in the subsequent drawings. This linear conveyor has a basic configuration similar to that of a module of a linear conveyor device described in WO2018/055709A1, for example.

FIGS. 1A and 1B show a linear conveyor M extended in the X direction, a base member 3 supporting the linear conveyor M from below, and a conveyor table 4 engaged with the linear conveyor M. The linear conveyor M is mounted on respective upper ends of three base members 3 juxtaposed to each other at a regular interval therebetween in the X direction, and drives the conveyor table 4 in the X direction by magnetic force. In this example, the linear conveyor M is formed from two module units 30 aligned in the X direction. Meanwhile, the number of the module units 20 forming the linear conveyor M is not limited to two but may be one, or three or more. A structure for attaching the two adjacent module units 20 to each other is not limited to the base member 3. The two adjacent module units 20 may be attached to each other by fastening a metallic plate or the like spanned over the two module units 20 to each of the module units 20 with a screw.

The module unit 20 includes a substrate 21 extended in the X direction. The substrate 21 is a flat plate having a rectangular shape in a plan view from the Z direction. Two guide rails 22 parallel to the X direction are arranged at an interval therebetween in the Y direction on an upper surface of the substrate 21. The upper surface of the substrate 21 is further mounted with a plurality of linear motor stators 23 juxtaposed in a line in the X direction at a predetermined alignment pitch P23, and a plurality of magnetic sensors 24 juxtaposed in a line in the X direction at a predetermined alignment pitch P24. The alignment pitch P24 of the magnetic sensors 24 is greater than the alignment pitch P23 of the linear motor stators 23. In the Y direction, the plurality of linear motor stators 23 is arranged between the two guide rails 22 and the plurality of magnetic sensors 24 is arranged between the linear motor stators 23 and one of the guide rails 22.

The linear motor stator 23 is an electromagnet formed from a coil and a core inserted in the coil. The conveyor table 4 is provided with a mover formed from a permanent magnet and a back yoke holding the permanent magnet. The linear motor stator 23 generates magnetic flux responsive to an applied current to apply magnetic propulsion force to the mover of the conveyor table 4, thereby driving the conveyor table 4 in the X direction. The conveyor table 4 is further mounted with a magnetic scale representing a position in the X direction. The magnetic sensor 24 reads the magnetic scale to detect the position of the conveyor table 4 in the X direction. Then, the conveyor table 4 is driven in the X direction by feedback control of a current to be applied to the linear motor stator 23 based on the position of the conveyor table 4 detected by the magnetic sensor 24.

The module unit 20 includes a cover member 25 having a rectangular shape in a plan view, the cover member 25 covering the guide rail 22, the linear motor stator 23, and the magnetic sensor 24 from above. The cover member 25 includes a support leg 251 projecting downward at the center in the Y direction. The support leg 251 is mounted on the upper surface of the substrate 21. A clearance between the cover member 25 and the substrate 21 is formed at each of both ends in the Y direction. Both end portions of the conveyor table 4 getting in between the cover member 25 and the substrate 21 through these clearances are engaged with the corresponding two guide rails 22.

The conveyor table 4 is capable of advancing from an end of the linear conveyor M toward the center of the linear conveyor M in the X direction to be engaged with the guide rails 22 of the linear conveyor M. The conveyor table 4 engaged with the guide rails 22 in this way is driven in the X direction by the linear conveyor M. The conveyor table 4 is also capable of exiting to the outside from an end of the linear conveyor M in the X direction to be removed from the guide rails 22 of the linear conveyor M.

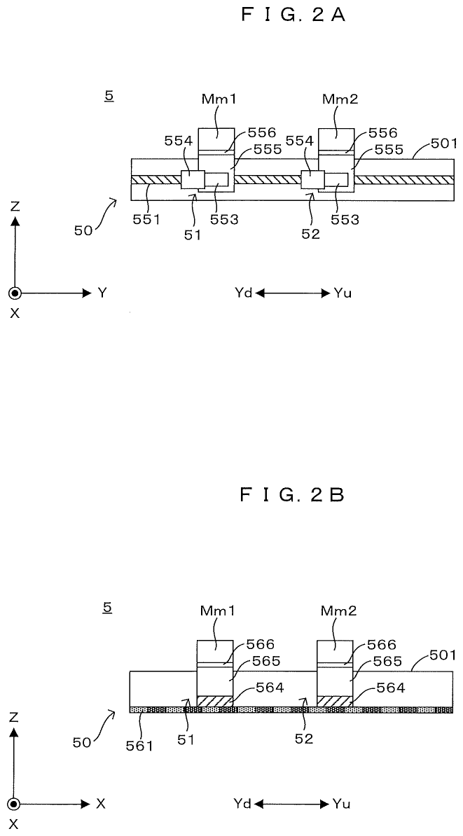

FIG. 2A is a side view schematically showing a first example of an internal configuration of a branch transport device according to the present disclosure. A Yd side and a Yu side in the Y direction pointed toward sides opposite to each other are shown as appropriate in FIG. 2A and in the subsequent drawings. A branch transport device 5 includes two movable linear conveyors Mm1, Mm2 aligned in parallel in the X direction. In the Y direction, the movable linear conveyor Mm1 is arranged on the Yd side relative to the movable linear conveyor Mm2, and the movable linear conveyor Mm2 is arranged on the Yu side relative to the movable linear conveyor Mm.

Each of the movable linear conveyors Mm1, Mm2 is a linear conveyor having the basic configuration described above using FIGS. 1A and 1B. Thus, the conveyor table 4 is engageable with and removable from the linear conveyor Mm1, Mm2 from an end of this movable linear conveyor Mm1, Mm2 in the X direction, and each of the movable linear conveyors Mm1, Mm2 drives the conveyor table 4 (slider) in the X direction engaged with this movable linear conveyor Mm1, Mm2.

The branch transport device 5 includes a drive mechanism 50 that drives the two movable linear conveyors Mm1, Mm2 in the Y direction. The drive mechanism 50 includes a first drive part 51 that drives the movable linear conveyor Mm1 in the Y direction, and a second drive part 52 that drives the movable linear conveyor Mm2 in the Y direction. In the Y direction, the first drive part 51 is arranged on the Yd side relative to the second drive part 52, and the second drive part 52 is arranged on the Yu side relative to the first drive part 51. The first drive part 51 and the second drive part 52 have configurations common to each other. Thus, the configuration of the first drive part 51 will be descried mainly while the configuration of the second drive part 52 will be given corresponding signs and description thereof will be omitted as appropriate.

According to the first example shown in FIG. 2A, the drive mechanism 50 is a ball screw type single-axis robot. Specifically, the drive mechanism 50 includes a housing 501 extended in the Y direction, and a screw shaft 551 extended parallel to the Y direction in the housing 501. The screw shaft 551 is fixed to the housing 501.

Meanwhile, the first drive part 51 includes a nut 553 threadedly engaged with the screw shaft 551, and a hollow motor 554 that drives the nut 553 to rotate the nut 553 relative to the screw shaft 551. The hollow motor 554 is fitted externally to the screw shaft 551. In other words, the screw shaft 551 penetrates a hollow part of the hollow motor 554 in the Y direction. A power supply line and a signal line for the hollow motor 554 are arranged by CABLEVEYOR (registered trademark) extended in the Y direction on a lateral side of the housing 501 in the X direction. The first drive part 51 includes a slider 555 supported by the housing 501 in such a manner as to be slidable in the Y direction. The hollow motor 554 is mounted on the slider 555. The first drive part 51 further includes a support plate 556 mounted on an upper surface of the slider 555, and the movable linear conveyor Mm1 is mounted on an upper surface of the support plate 556.

Thus, the first drive part 51 can drive the movable linear conveyor Mm1 in the Y direction by rotating the nut 553 by the hollow motor 554. Likewise, the second drive part 52 can drive the movable linear conveyor Mm2 in the Y direction by rotating the nut 553 by the hollow motor 554. According to this configuration, the first drive part 51 drives the movable linear conveyor Mm1 in the Y direction independently of the movable linear conveyor Mm2 and the second drive part 52 drives the movable linear conveyor Mm2 in the Y direction independently of the movable linear conveyor Mm1.

FIG. 2B is a side view schematically showing a second example of the internal configuration of the branch transport device according to the present disclosure. The first example in FIG. 2A and the second example in FIG. 2B differ from each other in that, while each of the movable linear conveyors Mm1, Mm2 is driven by the ball screw according to the first example, each of the movable linear conveyors Mm1, Mm2 is driven by a linear motor according to the second example. Here, a configuration different from the first example will be described mainly and a configuration common to the first example will be given corresponding signs and description thereof will be omitted as appropriate.

The drive mechanism 50 of the branch transport device 5 according to the second example includes a stator 561 extended in the Y direction at a bottom of the housing 501. The stator 561 has N poles and S poles of a permanent magnet aligned alternately in the Y direction.

Meanwhile, the first drive part 51 includes a mover 564 facing the stator 561 from above. The mover 564 has a coil arranged in such a manner as to face the stator 561. When the mover 564 (coil) generates a magnetic field, magnetic force is generated between the mover 564 and the stator 561 to move the mover 564 in the Y direction. A signal line for the mover 564 (coil) is arranged by CABLEVEYOR (registered trademark) extended in the Y direction on a lateral side of the housing 501 in the X direction. The first drive part 51 includes a slider 565 supported by the housing 501 in such a manner as to be slidable in the Y direction, and the mover 564 is mounted on a bottom surface of the slider 565. The first drive part 51 further includes a support plate 566 mounted on an upper surface of the slider 565, and the movable linear conveyor Mm1 is mounted on an upper surface of the support plate 566.

Thus, the first drive part 51 can drive the movable linear conveyor Mm1 in the Y direction by the mover 564. Likewise, the second drive part 52 can drive the movable linear conveyor Mm1 in the Y direction by the mover 564. According to this configuration, the first drive part 51 drives the movable linear conveyor Mm1 in the Y direction independently of the movable linear conveyor Mm2, and the second drive part 52 drives the movable linear conveyor Mm2 in the Y direction independently of the movable linear conveyor Mm1.

The branch transport device 5 having the above-described configuration includes the movable linear conveyor Mm1 (first movable linear conveyor) and the movable linear conveyor Mm2 (second movable linear conveyor) aligned in parallel in the X direction (transport direction). The branch transport device 5 further includes the first drive part 51 that drives the movable linear conveyor Mm1 in the Y direction (drive direction) and the second drive part 52 that drives the movable linear conveyor Mm2 in the Y direction. This allows the movable linear conveyor Mm1 to be driven in the Y direction by the first drive part 51 independently of the movable linear conveyor Mm2 and allows the movable linear conveyor Mm2 to be driven in the Y direction by the second drive part 52 independently of the movable linear conveyor Mm1. Thus, in parallel with a period when the movable linear conveyor Mm1 to which the conveyor table 4 transferred from a linear conveyor that is a branch source moves to a move destination and then motion at the move destination is completed, for example, it is possible for the movable linear conveyor Mm2 to conduct motion for another branch transport. In this way, efficient branch transport of the conveyor table 4 is possible.

The first drive part 51 is mounted on the movable linear conveyor Mm1 and moves in the Y direction to drives the movable linear conveyor Mm1 in the Y direction. The second drive part 52 is mounted on the movable linear conveyor Mm2 and moves in the Y direction to drive the movable linear conveyor Mm2 in the Y direction. This configuration allows the movable linear conveyor Mm1 to be driven in the Y direction independently of the movable linear conveyor Mm2 by the first drive part 51 mounted on the movable linear conveyor Mm1, and allows the movable linear conveyor Mm2 to be driven in the Y direction independently of the movable linear conveyor Mm1 by the second drive part 52 mounted on the movable linear conveyor Mm2.

According to the first example of the branch transport device 5 shown in FIG. 2A, the drive mechanism 50 includes the screw shaft 551 arranged parallel to the Y direction. The first drive part 51 includes the nut 553 (first nut) threadedly engaged with the screw shaft 551, and the hollow motor 554 (first motor) to drive the nut 553. The first drive part 51 moves in the Y direction by rotating the nut 553 relative to the screw shaft 551 using the hollow motor 554. That is, the hollow motor 554 (first motor) drives the nut 553 of a ball screw formed from the nut 553 (first nut) and the screw shaft 551 of the first drive part 51 to drive the movable linear conveyor Mm1 in the Y direction. Likewise, the second drive part 52 includes the nut 553 (second nut) threadedly engaged with the screw shaft 551, and the hollow motor 554 (second motor) to drive the nut 553. The second drive part 52 moves in the Y direction by rotating the nut 553 relative to the screw shaft 551 by the hollow motor 554. That is, the hollow motor 554 (second motor) drives the nut 553 of a ball screw formed from the nut 553 (second nut) and the screw shaft 551 of the second drive part 52 to drive the movable linear conveyor Mm2 in the Y direction. This configuration allows the movable linear conveyor Mm1 to be driven in the Y direction independently of the movable linear conveyor Mm2 by the hollow motor 554 of the first drive part 51, and allows the movable linear conveyor Mm2 to be driven in the Y direction independently of the movable linear conveyor Mm1 by the hollow motor 554 of the second drive part 52.

According to the second example of the branch transport device 5 shown in FIG. 2B, the drive mechanism 50 includes the stator 561 formed from the permanent magnet arranged parallel to the Y direction. The first drive part 51 includes the mover 564 (first mover) formed from the coil, and moves in the Y direction by magnetic force generated between the mover 564 and the stator 561. That is, the linear motor formed from the mover 564 of the first drive part 51 and the stator 561 drives the movable linear conveyor Mm1 in the Y direction. Likewise, the second drive part 52 includes the mover 564 (second mover) formed from the coil, and moves in the Y direction by magnetic force generated between the mover 564 and the stator 561. That is, the linear motor formed from the mover 564 of the second drive part 52 and the stator 561 drives the movable linear conveyor Mm2 in the Y direction. This configuration allows the movable linear conveyor Mm1 to be driven in the Y direction independently of the movable linear conveyor Mm2 by the mover 564 of the first drive part 51, and allows the movable linear conveyor Mm2 to be driven in the Y direction independently of the movable linear conveyor Mm1 by the mover 564 of the second drive part 52.

Described next is a conveyor table transport system S (hereinafter abbreviated as a “transport system S” as appropriate) using the branch transport device 5 having the configuration in FIG. 2A or 2B. In the present description, terms “movable linear conveyor” and “fixed linear conveyor” are used in appropriate cases. The “movable linear conveyor” is a linear conveyor to be moved relative to an installation surface of the transport system S by being driven by the branch transport device 5 in the manner described above. By contrast, the “fixed linear conveyor” is a linear conveyor not to move relative to the installation surface of the transport system S. Like the movable linear conveyor, the fixed linear conveyor is a linear conveyor having the basic configuration described above by referring to FIGS. 1A and 1B.

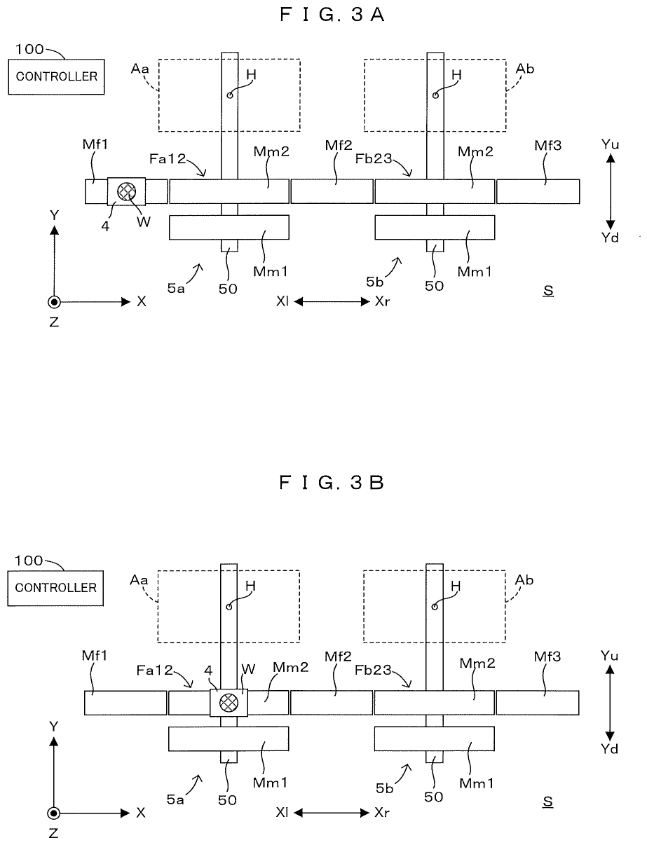

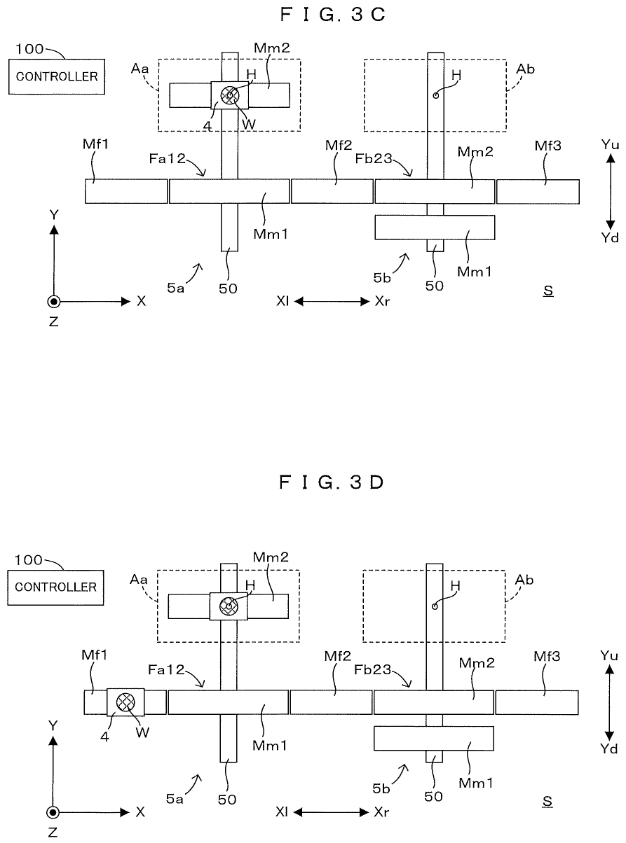

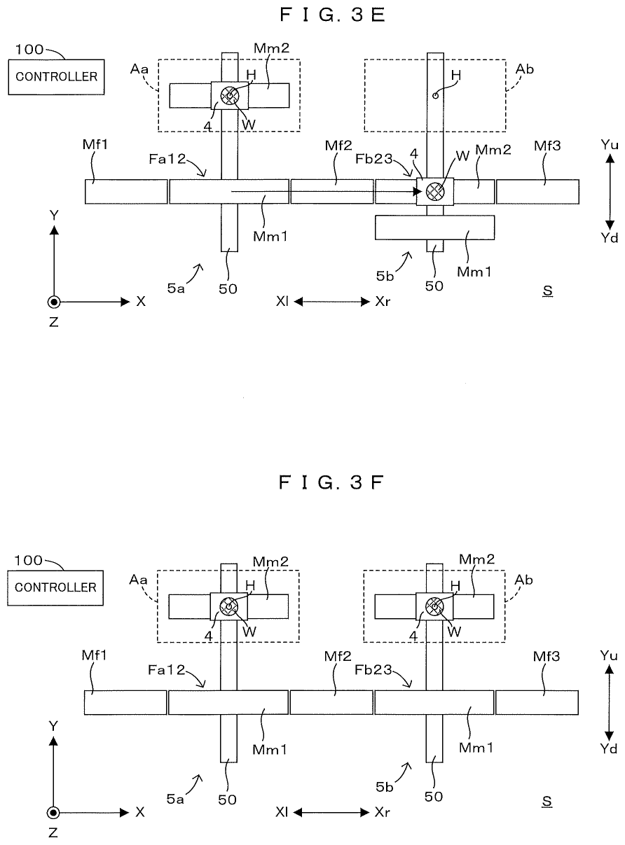

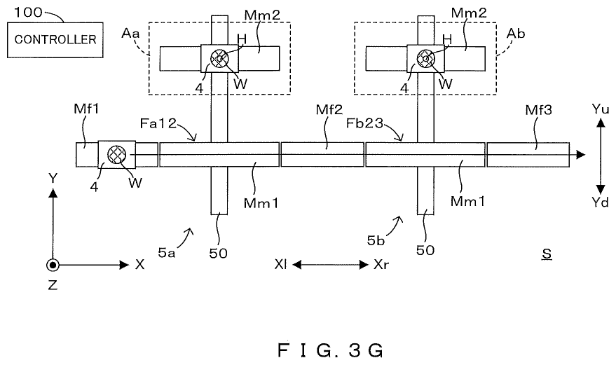

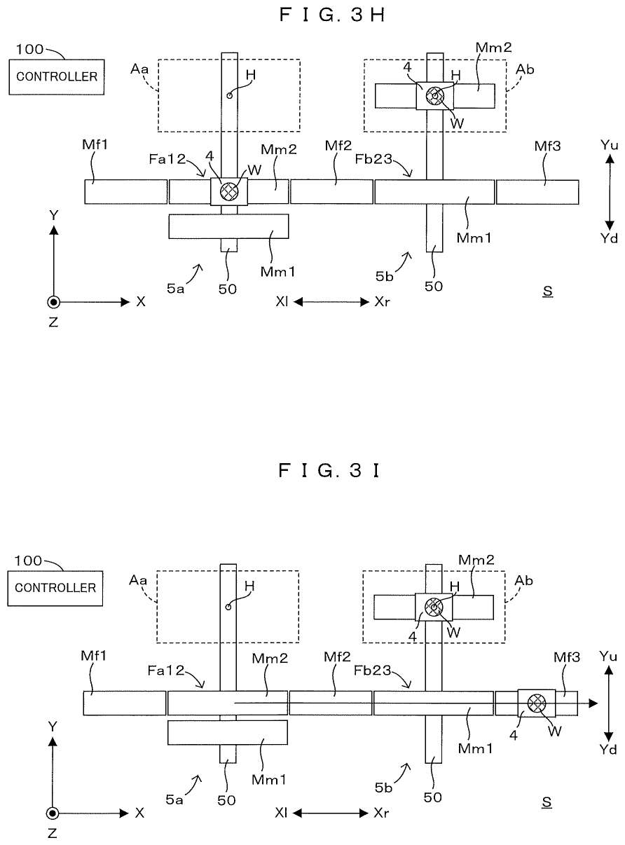

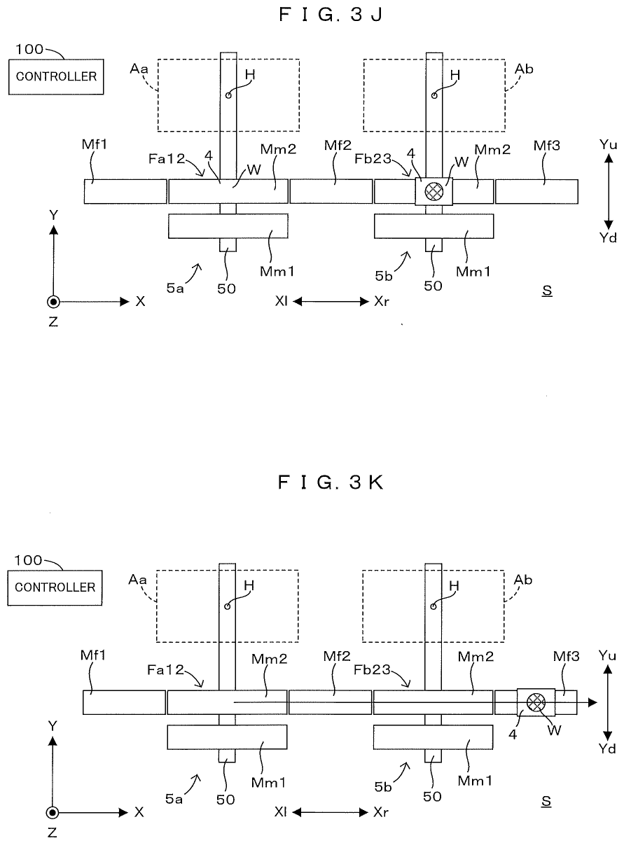

FIGS. 3A to 3K schematically show a first example of the conveyor table transport system according to the present disclosure. The Xl side and the Xr side in the X direction pointed toward sides opposite to each other are shown as appropriate in FIGS. 3A to 3K and in the subsequent drawings. The conveyor table transport system S (hereinafter abbreviated as a “transport system S” as appropriate) according to the first example includes a plurality of (three) fixed linear conveyors Mf1 to Mf3 aligned in series at intervals therebetween in the X direction.

The transport system S includes a controller 100 that controls the system as a whole in an integrated manner. The controller 100 controls drive of the conveyor table 4 by the linear conveyors including the fixed linear conveyors Mf1 to Mf3 and the movable linear conveyors Mm1, Mm2, and drive of the movable linear conveyors Mm1, Mm2 by the first drive part 51 and the second drive part 52 of the branch transport device 5. As a result of implementation of the control by the controller 100, each motion described below is conducted in the transport system S. The controller 100 is formed from a processor such as a CPU (central processing unit) or an FPGA (field programmable gate array), for example. A corresponding controller 100 is also provided in a transport system S according to each of other examples (including a second example and the subsequent examples) described subsequently to the first example.

A facing position Fa12 and a facing position Fb23 are set in the transport system S. The facing position Fa12 faces the fixed linear conveyor Mf1 and the fixed linear conveyor Mf2 in the X direction (in other words, being between the fixed linear conveyor Mf1 and the fixed linear conveyor Mf2). The facing position Fb23 faces the fixed linear conveyor Mf2 and the fixed linear conveyor Mf3 in the X direction (in other words, being between the fixed linear conveyor Mf2 and the fixed linear conveyor Mf3).

The facing position Fa12 is positioned on the Xl side relative to the facing position Fb23. The facing position Fb23 is positioned on the Xr side relative to the facing position Fa12. The fixed linear conveyor Mf1 faces the facing position Fa12 from the Xl side. The fixed linear conveyor Mf2 faces the facing position Fa12 from the Xr side. The fixed linear conveyor Mf2 faces the facing position Fb23 from the Xl side. The fixed linear conveyor Mf3 faces the facing position Fb23 from the Xr side.

A work area Aa is provided on the Yu side relative to the facing position Fa12 in the Y direction. A work area Ab is provided on the Yu side relative to the facing position Fb23 in the Y direction. A working head H is provided in each of the work areas Aa and Ab. The working head H conducts predetermined work on a workpiece W placed on the conveyor table 4. For example, the working head H is a dispenser from which a coating liquid such as an adhesive or solder paste is ejected, and conducts application of the coating liquid to the workpiece W. Meanwhile, in addition to the work given in this example, work assumed to be conducted by the working head H includes welding, painting, or appearance inspection.

In the transport system S, a branch transport device 5a is arranged between the two fixed linear conveyors Mf1, Mf2 next to each other in the X direction. As described above, the branch transport device 5a drives the movable linear conveyor Mm1 in the Y direction by the first drive part 51 and drives the movable linear conveyor Mm2 in the Y direction by the second drive part 52. Thus, each of the movable linear conveyors Mm1, Mm2 is movable in the Y direction independently of each other and can be positioned at the facing position Fa12 or in the work area Aa.

In the transport system S, a branch transport device 5b is arranged between the two fixed linear conveyors Mf2, Mf3 next to each other in the X direction. As described above, the branch transport device 5b drives the movable linear conveyor Mm1 in the Y direction by the first drive part 51 and drives the movable linear conveyor Mm2 in the Y direction by the second drive part 52. Thus, each of the movable linear conveyors Mm1, Mm2 is movable in the Y direction independently of each other and can be positioned at the facing position Fb23 or in the work area Ab.

In this transport system S, the conveyor table 4 can be transported by taking a procedure shown in FIGS. 3A to 3K. In FIG. 3A, the conveyor table 4 on which the workpiece W is placed is held by the fixed linear conveyor Mf1. The movable linear conveyor Mm2 positioned at the facing position Fa12 faces the fixed linear conveyor Mf1 from the Xr side. The movable linear conveyor Mm1 retreats toward the Yd side from the facing position Fa12. Then, as shown in FIG. 3B, the conveyor table 4 is transferred from the fixed linear conveyor Mf1 to the movable linear conveyor Mm1 at the facing position Fa12.

Then, as shown in FIG. 3C, the movable linear conveyor Mm2 holding the conveyor table 4 moves from the facing position Fa12 to the work area Aa. By doing so, it becomes possible for the working head H to conduct work on the workpiece W placed on the conveyor table 4. While the working head H is conducting work, the movable linear conveyor Mm2 and the second drive part 52 of the branch transport device 5a function as an XY table to adjust the position of the workpiece W in the X direction and the Y direction relative to the working head H. If the working head H is to conduct coating, for example, the movable linear conveyor Mm2 drives the conveyor table 4 in the X direction to allow a coating liquid to be applied parallel to the X direction. Furthermore, the first drive part 51 drives the conveyor table 4 in the Y direction to allow the coating liquid to be applied parallel to the Y direction. If the working head H is to conduct inspection, the movable linear conveyor Mm2 and the second drive part 52 adjust the position of the conveyor table 4 in the X direction and the Y direction so as to cause an inspection part of the workpiece W to face the working head H.

As shown in FIG. 3C, in parallel with the move of the movable linear conveyor Mm2 from the facing position Fa12 to the work area Aa, the movable linear conveyor Mm1 moves to the facing position Fa12. In FIG. 3D, the conveyor table 4 having been loaded into the fixed linear conveyor Mf1 from an upstream process is held by the fixed linear conveyor Mf1. At the branch transport device 5b, the movable linear conveyor Mm2 positioned at the facing position Fb23 faces the fixed linear conveyor Mf2 from the Xr side. The movable linear conveyor Mm1 retreats toward the Yd side from the facing position Fb23. Then, as shown in FIG. 3E, the conveyor table 4 is transferred from the fixed linear conveyor Mf1 to the movable linear conveyor Mm2 at the facing position Fb23 through the movable linear conveyor Mm1 at the facing position Fa12 and the fixed linear conveyor Mf2.

Next, as shown in FIG. 3F, the movable linear conveyor Mm2 holding the conveyor table 4 moves from the facing position Fb23 to the work area Ab. By doing so, it becomes possible for the working head H to conduct work on the workpiece W placed on the conveyor table 4. While the working head H is conducting work, the movable linear conveyor Mm2 and the second drive part 52 of the branch transport device 5b function as an XY table to adjust the position of the workpiece W in the X direction and the Y direction relative to the working head H.

As shown in FIG. 3G, while the movable linear conveyor Mm2 of the branch transport device 5a is in the work area Aa and the movable linear conveyor Mm2 of the branch transport device 5b is in the work area Ab, it is also possible to form a transport line for transporting the conveyor table 4 from the upstream process toward a downstream process by the respective movable linear conveyors Mm1 of the branch transport devices 5a and 5b. More specifically, positioning the movable linear conveyor Mm1 of the branch transport device 5a at the facing position Fa12 and positioning the movable linear conveyor Mm1 of the branch transport device 5b at the facing position Fb23 causes the movable linear conveyors Mm1 to form the transport line extended in the X direction together with the fixed linear conveyors Mf1 to Mf3. The conveyor table 4 is transported by this transport line in the X direction.

When the work in the work area Aa is completed, the branch transport device 5a moves the movable linear conveyor Mm2 from the work area Aa to the facing position Fa12 while retreating the movable linear conveyor Mm1 toward the Yd side from the facing position Fa12, as shown in FIG. 3H. Next, as shown in FIG. 3I, while the branch transport device 5b positions the movable linear conveyor Mm1 at the facing position Fb23, the conveyor table 4 is transferred from the movable linear conveyor Mm1 at the facing position Fa12 to the fixed linear conveyor Mf3 through the fixed linear conveyor Mf2 and the movable linear conveyor Mm1. Further, the conveyor table 4 is unloaded to the downstream process.

When the work in the work area Ab is completed, the branch transport device 5b moves the movable linear conveyor Mm2 from the work area Ab to the facing position Fb23 while retreating the movable linear conveyor Mm1 toward the Yd side from the facing position Fb23, as shown in FIG. 3J. Next, as shown in FIG. 3K, the conveyor table 4 is transferred from the movable linear conveyor Mm1 at the facing position Fb23 to the fixed linear conveyor Mf3. Further, the conveyor table 4 is unloaded to the downstream process.

As described above, according to the first example of the transport system S shown in FIGS. 3A to 3K, the transport system S is provided with the branch transport device 5 that drives the movable linear conveyor Mm1 and the movable linear conveyor Mm2 in the Y direction independently of each other, and the fixed linear conveyors Mf1, Mf2, Mf3 (line linear conveyors). At the branch transport device 5a, for example, the movable linear conveyor Mm1 (first movable linear conveyor) is positioned on the Yd side (first side) in the Y direction relative to the movable linear conveyor Mm2 (second movable linear conveyor), and the movable linear conveyor Mm2 is positioned on the Yu side (second side) in the Y direction relative to the movable linear conveyor Mm1. While the first drive part 51 (first drive part) positions the movable linear conveyor Mm1 at the facing position Fa12 (transport facing position) facing the fixed linear conveyors Mf1, Mf2 in the Y direction, the conveyor table 4 (first conveyor table) is transferred between the movable linear conveyor Mm1 and the fixed linear conveyor Mf1, Mf2 (FIGS. 3C to 3E, 3G). Furthermore, while the second drive part 52 positions the movable linear conveyor Mm2 at the facing position Fa12, the conveyor table 4 (second conveyor table) is transferred between the movable linear conveyor Mm2 and the fixed linear conveyor Mf1, Mf2 (FIGS. 3A, 3B, 3H, 3I). Corresponding motions are also made at the branch transport device 5b. In this configuration, while the controller 100 controls the respective positions of the movable linear conveyor Mm1 and the movable linear conveyor Mm2 in the Y direction independently of each other, it is possible to transport the conveyor table 4 by the movable linear conveyor Mm1 and transport the conveyor table 4 by the movable linear conveyor Mm2.

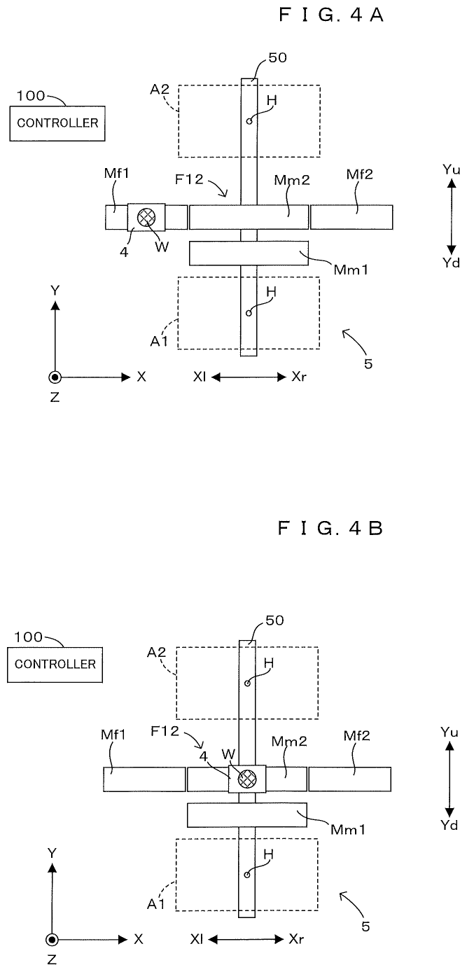

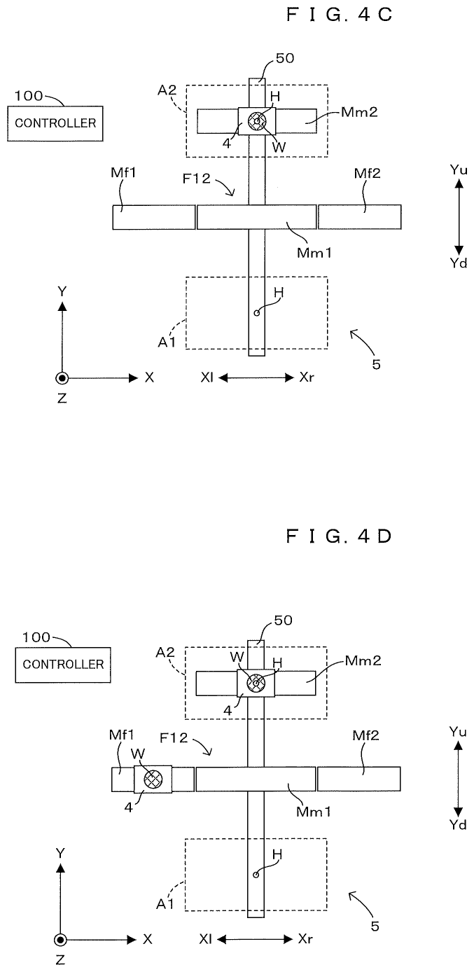

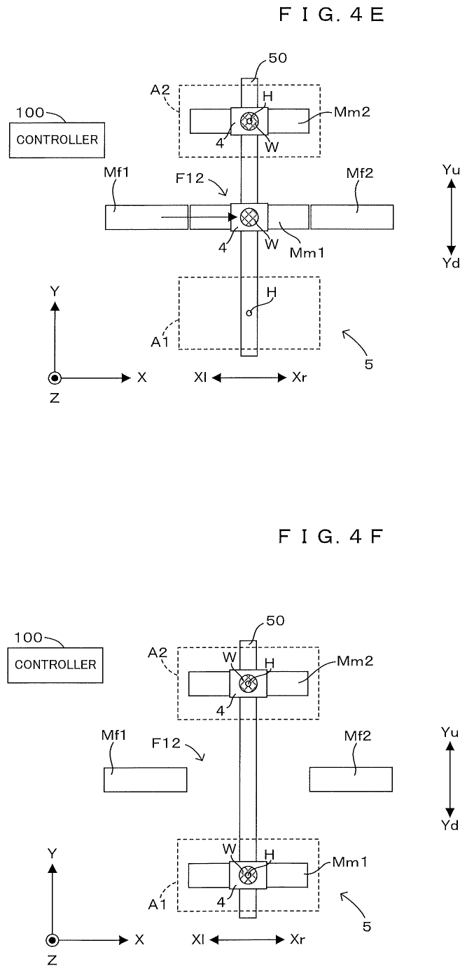

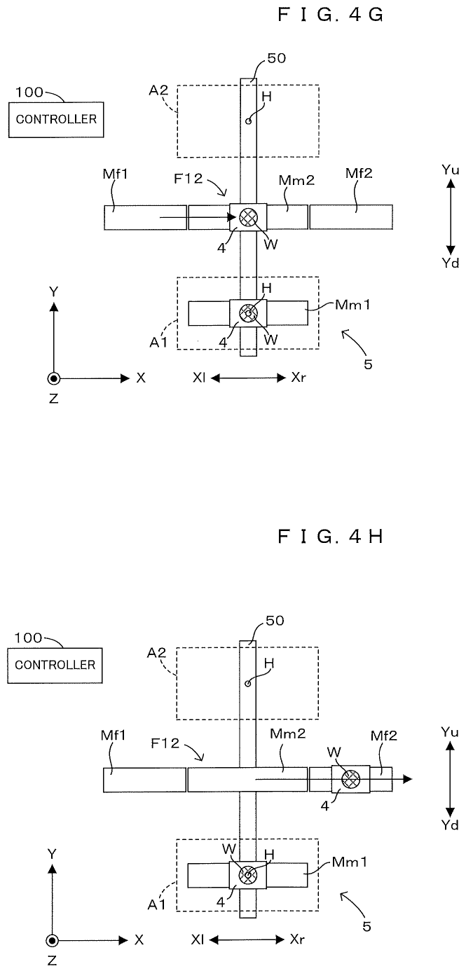

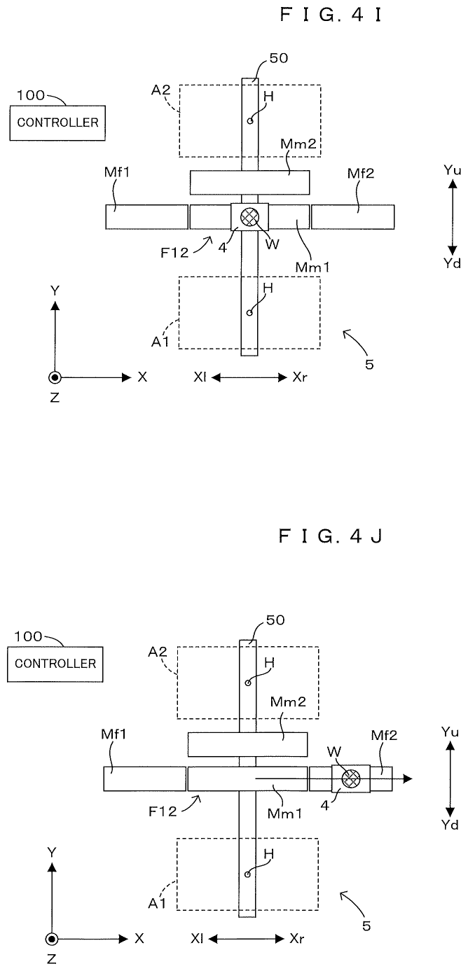

FIGS. 4A to 4J schematically show a second example of the conveyor table transport system according to the present disclosure. The transport system S according to the second example includes a plurality of (two) fixed linear conveyors Mf1, Mf2 aligned in series at an interval therebetween in the X direction.

A facing position F12, which faces the fixed linear conveyor Mf1 and the fixed linear conveyor Mf2 in the X direction (in other words, positioned between the fixed linear conveyor Mf1 and the fixed linear conveyor Mf2), is set in the transport system S. The fixed linear conveyor Mf1 is positioned on the Xl side relative to the fixed linear conveyor Mf2. The fixed linear conveyor Mf2 is positioned on the Xr side relative to the fixed linear conveyor Mf1. The fixed linear conveyor Mf1 faces the facing position F12 from the Xl side. The fixed linear conveyor Mf2 faces the facing position F12 from the Xr side.

A work area A1 is provided on the Yd side relative to the facing position F12 in the Y direction. A work area A2 is provided on the Yu side relative to the facing position F12 in the Y direction. A working head H is provided in each of the work areas A1, A2. The working head H conducts predetermined work on a workpiece W placed on the conveyor table 4.

In the transport system S, the branch transport device 5 is arranged between the two fixed linear conveyors Mf1, Mf2 next to each other in the X direction. As described above, the branch transport device 5 drives the movable linear conveyor Mm1 in the Y direction by the first drive part 51 and drives the movable linear conveyor Mm2 in the Y direction by the second drive part 52. Thus, the movable linear conveyors Mm1, Mm2 are both movable in the Y direction independently of each other and can be positioned at the facing position F12 or in the work area A1, A2.

In this transport system S, the conveyor table 4 can be transported by taking a procedure shown in FIGS. 4A to 4J. In FIG. 4A, the conveyor table 4 on which the workpiece W is placed is held by the fixed linear conveyor Mf1. The movable linear conveyor Mm2 positioned at the facing position F12 faces the fixed linear conveyor Mf1 from the Xr side. The movable linear conveyor Mm1 retreats toward the Yd side from the facing position F12. Then, as shown in FIG. 4B, the conveyor table 4 is transferred from the fixed linear conveyor Mf1 to the movable linear conveyor Mm2 at the facing position F12.

Next, as shown in FIG. 4C, the movable linear conveyor Mm2 holding the conveyor table 4 moves from the facing position F12 to the work area A2. By doing so, it becomes possible for the working head H to conduct work on the workpiece W placed on the conveyor table 4. While the working head H is conducting work, the movable linear conveyor Mm2 and the second drive part 52 of the branch transport device 5 function as an XY table to adjust the position of the workpiece W in the X direction and the Y direction relative to the working head H.

As shown in FIG. 4C, in parallel with the move of the movable linear conveyor Mm2 from the facing position F12 to the work area A2, the movable linear conveyor Mm1 moves to the facing position F12. In FIG. 4D, the conveyor table 4 having been loaded into the fixed linear conveyor Mf1 from an upstream process is held by the fixed linear conveyor Mf1. Then, as shown in FIG. 4E, the conveyor table 4 is transferred from the fixed linear conveyor Mf1 to the movable linear conveyor Mm1 at the facing position F12.

Then, as shown in FIG. 4F, the movable linear conveyor Mm1 holding the conveyor table 4 moves from the facing position F12 to the work area A1. By doing so, it becomes possible for the working head H to conduct work on the workpiece W placed on the conveyor table 4. While the working head H is conducting work, the movable linear conveyor Mm1 and the first drive part 51 of the branch transport device 5 function as an XY table to adjust the position of the workpiece W in the X direction and the Y direction relative to the working head H.

When the work in the work area A2 is completed, the branch transport device 5 moves the movable linear conveyor Mm2 from the work area A2 to the facing position F12, as shown in FIG. 4G. Next, as shown in FIG. 4H, the conveyor table 4 is transferred from the movable linear conveyor Mm2 at the facing position F12 to the fixed linear conveyor Mf2, Further, the conveyor table 4 is unloaded to a downstream process.

When the work in the work area A1 is completed, the branch transport device 5 moves the movable linear conveyor Mm1 from the work area A1 to the facing position F12 while retreating the movable linear conveyor Mm2 toward the Yu side from the facing position F12, as shown in FIG. 4I. Next, as shown in FIG. 4J, the conveyor table 4 is transferred from the movable linear conveyor Mm1 at the facing position F12 to the fixed linear conveyor Mf2. Further, the conveyor table 4 is unloaded to the downstream process.

As described above, according to the second example of the transport system S shown in FIGS. 4A to 4J, provided is the working head H (first working unit) arranged in the work area A1 (first work area) on the Yd side (first side) in the Y direction relative to the facing position F12 (transport facing position). In the work area A1, work (first work) is conducted on the workpiece W (first workpiece) supported by the movable linear conveyor Mm1 (first conveyor table) (FIGS. 4F, 4G). In particular, the first drive part 51 moves the movable linear conveyor Mm1 holding the conveyor table 4 to the work area A1. In the work area A1, the first drive part 51 moves the movable linear conveyor Mm1 in the Y direction and the movable linear conveyor Mm1 moves the conveyor table 4 in the X direction, thereby causing the working head H, the first drive part 51, and the movable linear conveyor Mm1 to conduct the work in cooperation with each other. This configuration allows the movable linear conveyor Mm1 holding the conveyor table 4 to move to the work area A1 independently of the movable linear conveyor Mm2. Furthermore, in the work area A1, the first drive part 51 and the movable linear conveyor Mm1 function together as an XY table to contribute to conduct of the work.

Provided is the working head H (second working unit) arranged in the work area A2 (second work area) on the Yu side (second side) in the Y direction relative to the facing position F12 (transport facing position). In the work area A2, work (second work) is conducted on the workpiece W (second workpiece) supported by the movable linear conveyor Mm2 (second conveyor table) (FIGS. 4C to 4F). In particular, the second drive part 52 moves the movable linear conveyor Mm2 holding the conveyor table 4 to the work area A2. In the work area A2, the second drive part 52 moves the movable linear conveyor Mm2 in the Y direction and the movable linear conveyor Mm2 moves the conveyor table 4 in the X direction, thereby causing the working head H, the second drive part 52, and the movable linear conveyor Mm2 to conduct the work in cooperation with each other. This configuration allows the movable linear conveyor Mm2 holding the conveyor table 4 to move to the work area A2 independently of the movable linear conveyor Mm1. Furthermore, in the work area A2, the second drive part 52 and the movable linear conveyor Mm2 function together as an XY table to contribute to conduct of the work.

A period when the work (first work) is conducted in the work area A1 and a period when the work (second work) is conducted in the work area A2 overlap each other at least partially (FIG. 4F). In this way, the work in the work area A1 and the work in the work area A2 are conducted efficiently in parallel.

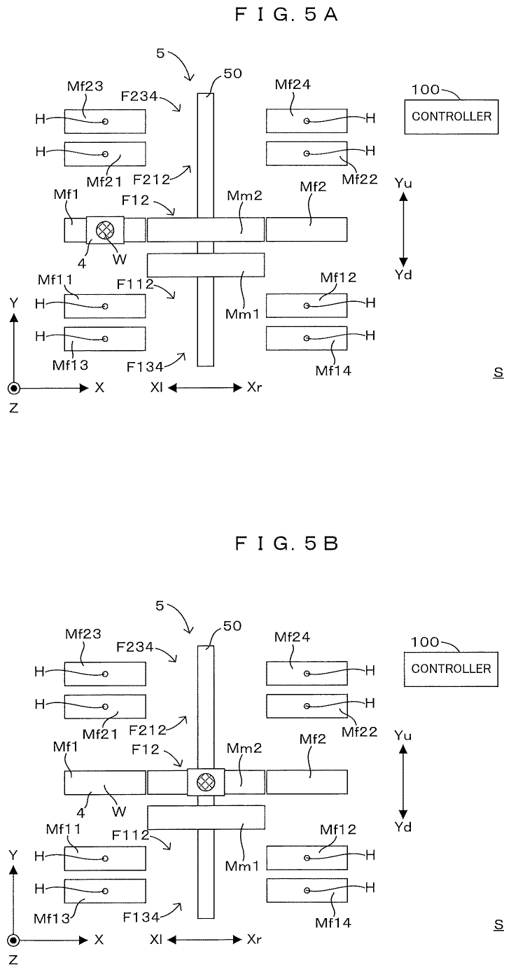

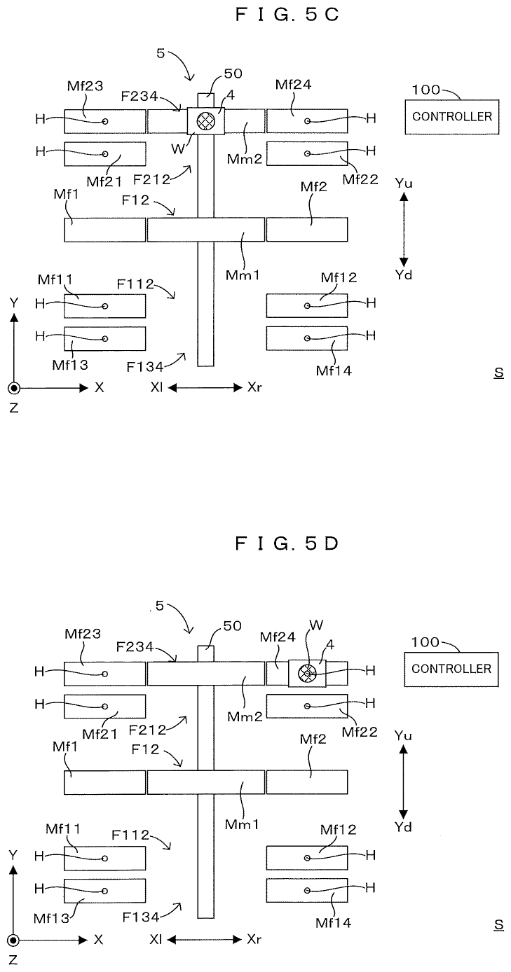

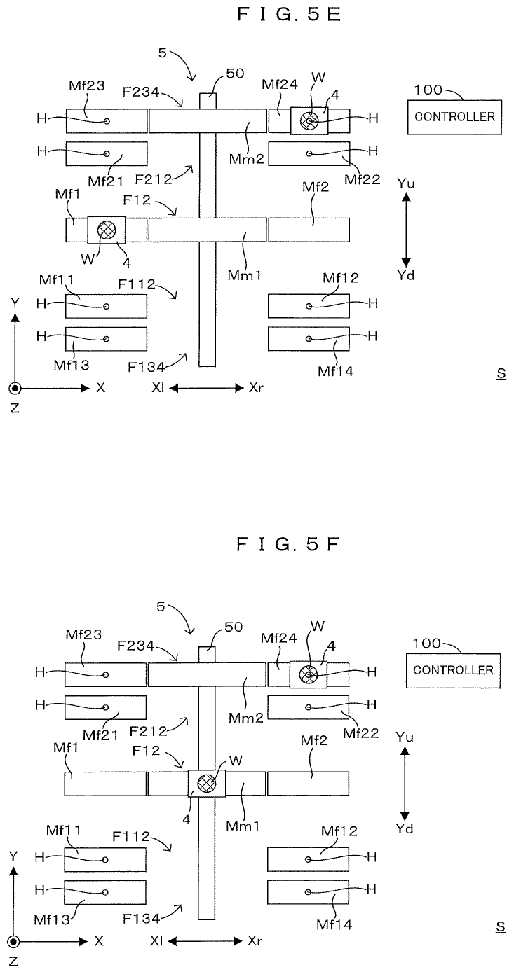

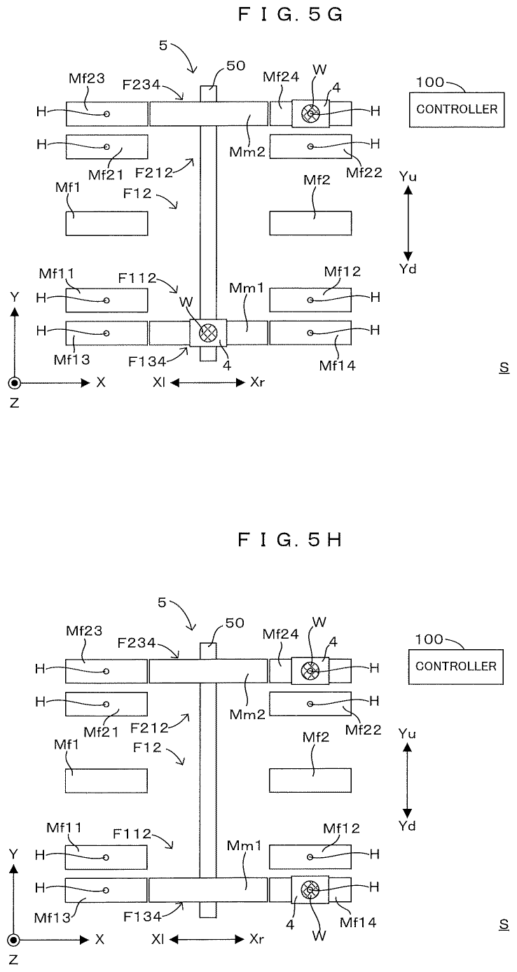

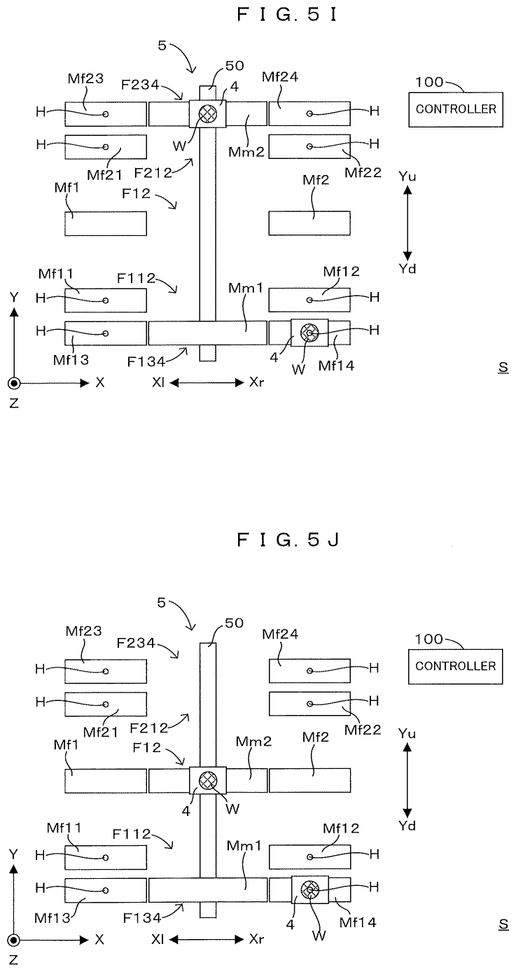

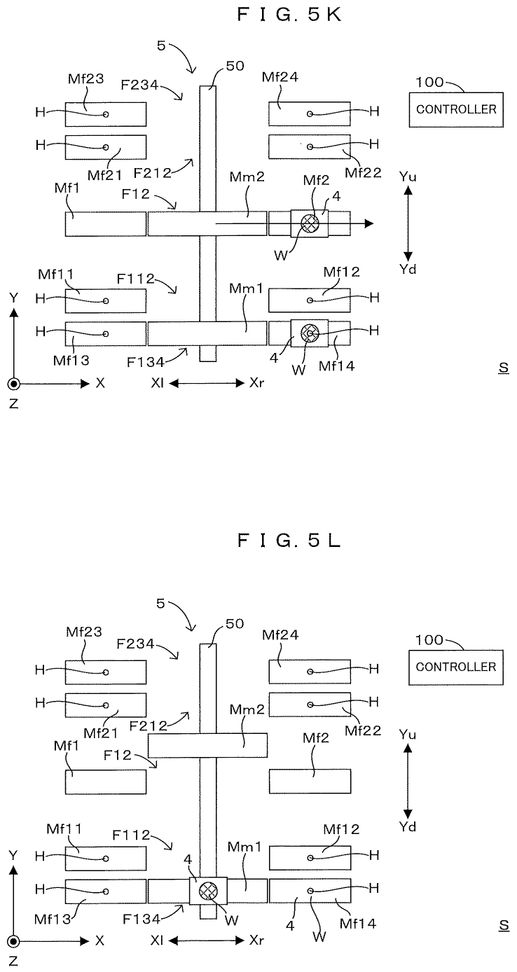

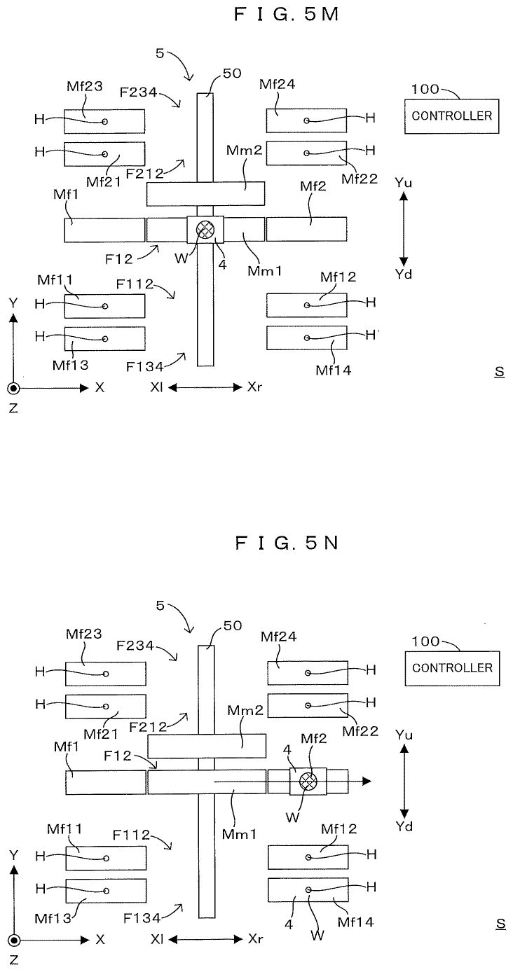

FIGS. 5A to 5N schematically show a third example of the conveyor table transport system according to the present disclosure. The transport system S according to the third example includes a plurality of (two) fixed linear conveyors Mf1, Mf2 aligned in series at an interval therebetween in the X direction.

A facing position F12, which faces the fixed linear conveyor Mf1 and the fixed linear conveyor Mf2 in the X direction (in other words, positioned between the fixed linear conveyor Mf1 and the fixed linear conveyor Mf2), is set in the transport system S. The fixed linear conveyor Mf1 is positioned on the Xl side relative to the fixed linear conveyor Mf2. The fixed linear conveyor Mf2 is positioned on the Xr side relative to the fixed linear conveyor Mf1. The fixed linear conveyor Mf1 faces the facing position F12 from the Xl side. The fixed linear conveyor Mf2 faces the facing position F12 from the Xr side.

In the transport system S, the branch transport device 5 is arranged between the two fixed linear conveyors Mf1, Mf2 next to each other in the X direction. As described above, the branch transport device 5 drives the movable linear conveyor Mm1 in the Y direction by the first drive part 51 and drives the movable linear conveyor Mm2 in the Y direction by the second drive part 52. Thus, the movable linear conveyors Mm1, Mm2 are both movable in the Y direction independently of each other and can be positioned at the facing position F12.

A plurality of (four) fixed linear conveyors Mf11 to Mf14 is provided on the Yd side in the Y direction relative to the facing position F12. The two fixed linear conveyors Mf11, Mf12 are aligned in series at an interval therebetween in the X direction, in particular, are arranged on opposite sides of the branch transport device 5 in such a manner as to interpose the branch transport device 5 therebetween. A facing position F112 is provided that faces the fixed linear conveyor Mf11 and the fixed linear conveyor Mf12 in the X direction.

The two fixed linear conveyors Mf13, Mf14 are aligned in series at an interval therebetween in the X direction, in particular, are arranged on the opposite sides of the branch transport device 5 in such a manner as to interpose the branch transport device 5 therebetween. A facing position F134 is provided that faces the fixed linear conveyor Mf13 and the fixed linear conveyor Mf14 in the X direction. Meanwhile, the first drive part 51 allows the movable linear conveyor Mm1 to be positioned at the facing position F112 or the facing position F134 by driving the movable linear conveyor Mm1. A working head H faces each of the fixed linear conveyors Mf11 to Mf14 from above. The working head H conducts predetermined work on a workpiece W placed on the conveyor table 4 held by the fixed linear conveyors Mf11 to Mf14.

A plurality of (four) fixed linear conveyors Mf21 to Mf24 is provided on the Yu side in the Y direction relative to the facing position F12. The two fixed linear conveyors Mf21 and Mf22 are aligned in series at an interval therebetween in the X direction, in particular, are arranged on the opposite sides of the branch transport device 5 in such a manner as to interpose the branch transport device 5 therebetween. A facing position F212 is provided that faces the fixed linear conveyor Mf21 and the fixed linear conveyor Mf22 in the X direction.

The two fixed linear conveyors Mf23 and Mf24 are aligned in series at an interval therebetween in the X direction, in particular, are arranged on the opposite sides of the branch transport device 5 in such a manner as to interpose the branch transport device 5 therebetween. A facing position F234 is provided that faces the fixed linear conveyor Mf23 and the fixed linear conveyor Mf24 in the X direction. Meanwhile, the second drive part 52 allows the movable linear conveyor Mm2 to be positioned at the facing position F212 or the facing position F234 by driving the movable linear conveyor Mm2. The working head H faces each of the fixed linear conveyors Mf21 to Mf24 from above. The working head H conducts predetermined work on the workpiece W placed on the conveyor table 4 held by the fixed linear conveyors Mf21 to Mf24.

In this transport system S, the conveyor table 4 can be transported by taking a procedure shown in FIGS. 5A to 5L. In FIG. 5A, the conveyor table 4 on which the workpiece W is placed is held by the fixed linear conveyor Mf1. The movable linear conveyor Mm2 at the facing position F12 faces the fixed linear conveyor Mf1 from the Xr side. The movable linear conveyor Mm1 retreats toward the Yd side from the facing position F12. Then, as shown in FIG. 5B, the conveyor table 4 is transferred from the fixed linear conveyor Mf1 to the movable linear conveyor Mm2 at the facing position F12.

Next, as shown in FIG. 5C, the movable linear conveyor Mm2 holding the conveyor table 4 moves from the facing position F12 to the facing position F234. In parallel with the move of the movable linear conveyor Mm2 from the facing position F12 to the facing position F234, the movable linear conveyor Mm1 moves to the facing position F12. Then, as shown in FIG. 5D, the conveyor table 4 is transferred from the movable linear conveyor Mm2 at the facing position F234 to the fixed linear conveyor Mf24. By doing so, it becomes possible for the working head H facing the fixed linear conveyor Mf24 to conduct work on the workpiece W placed on the conveyor table 4.

In FIG. 5E, the conveyor table 4 having been transported to the fixed linear conveyor Mf1 from an upstream process is held by the fixed linear conveyor Mf1. Then, as shown in FIG. 5F, the conveyor table 4 is transferred from the fixed linear conveyor Mf1 to the movable linear conveyor Mm1 at the facing position F12.

Next, as shown in FIG. 5G, the movable linear conveyor Mm1 holding the conveyor table 4 moves from the facing position F12 to the facing position F134. Then, as shown in FIG. 5H, the conveyor table 4 is transferred from the movable linear conveyor Mm1 at the facing position F134 to the fixed linear conveyor Mf14. By doing so, it becomes possible for the working head H facing the fixed linear conveyor Mf14 to conduct work on the workpiece W placed on the conveyor table 4.

When the work at the fixed linear conveyor Mf24 is completed, the conveyor table 4 is transferred from the fixed linear conveyor Mf24 to the movable linear conveyor Mm2 at the facing position F234, as shown in FIG. 5I. Next, as shown in FIG. 5J, the branch transport device 5 moves the movable linear conveyor Mm2 from the facing position F234 to the facing position F12. Then, as shown in FIG. 5K, the conveyor table 4 is transferred from the movable linear conveyor Mm2 at the facing position F12 to the fixed linear conveyor Mf2. Further, the conveyor table 4 is unloaded to a downstream process.

When the work at the fixed linear conveyor Mf14 is completed, the conveyor table 4 is transferred from the fixed linear conveyor Mf14 to the movable linear conveyor Mm1 at the facing position F134, as shown in FIG. 5L. Next, as shown in FIG. 5M, the branch transport device 5 moves the movable linear conveyor Mm1 from the facing position F134 to the facing position F12. At this time, the movable linear conveyor Mm retreats toward the Yu side from the facing position F12. Then, as shown in FIG. 5N, the conveyor table 4 is transferred from the movable linear conveyor Mm1 at the facing position F12 to the fixed linear conveyor Mf2. Further, the conveyor table 4 is unloaded to the downstream process.

As described above, according to the third example of the transport system S shown in FIGS. 5A to 5N, provided are the fixed linear conveyors Mf11 to Mf14 (first work linear conveyor) facing the facing position F112, F134 (first work facing position) arranged on the Yd side (first side) in the Y direction (drive direction) relative to the facing position F12 (transport facing position) in the Y direction. The first drive part 51 moves the movable linear conveyor Mm1 (first movable linear conveyor) holding the conveyor table 4 (first conveyor table) to the facing position F134, and the conveyor table 4 is transferred from the movable linear conveyor Mm1 at the facing position F134 to the fixed linear conveyor Mf14 (FIGS. 5G to 5H). Then, work (first work) is conducted on the workpiece W (first workpiece) supported by the conveyor table 4 held by the fixed linear conveyor Mf14 (FIGS. 5H to 5K). In this configuration, it is possible to move the movable linear conveyor Mm1 holding the conveyor table 4 to the facing position F112, F134 independently of the movable linear conveyor Mm2 and to transfer the conveyor table 4 from the movable linear conveyor Mm1 to the fixed linear conveyors Mf11 to Mf14.

Provided are the fixed linear conveyors Mf21 to Mf24 (second work linear conveyor) facing the facing position F212 or F234 (second work facing position) arranged on the Yu side in the Y direction relative to the facing position F12 in the Y direction (transport direction). The second drive part 52 moves the movable linear conveyor Mm2 (second movable linear conveyor) holding the conveyor table 4 (second conveyor table) to the facing position F234, and the conveyor table 4 is transferred from the movable linear conveyor Mm2 at the facing position F234 to the fixed linear conveyor Mf24 (FIGS. 5C and 5D). Then, work (second work) is conducted on the workpiece W (second workpiece) supported by the conveyor table 4 held by the fixed linear conveyor Mf24 (FIGS. 5D to 5F). In this configuration, it is possible to move the movable linear conveyor Mm2 holding the conveyor table 4 to the facing position F212 or F234 independently of the movable linear conveyor Mm1 and to transfer the conveyor table 4 from the movable linear conveyor Mm2 to the fixed linear conveyors Mf21 to Mf24.

A period when the work (first work) is conducted on the workpiece W on the conveyor table 4 held by the fixed linear conveyor Mf14 and a period when the work (second work) is conducted on the workpiece W on the conveyor table 4 held by the fixed linear conveyor Mf24 overlap each other at least partially (FIG. 5H). In this way, the work at the fixed linear conveyor Mf14 and the work at the fixed linear conveyor Mf24 are conducted efficiently in parallel.

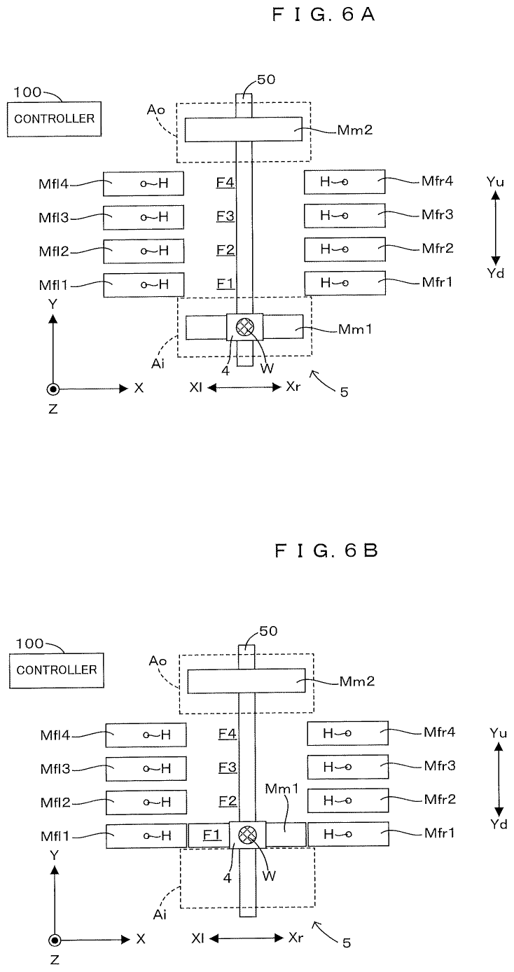

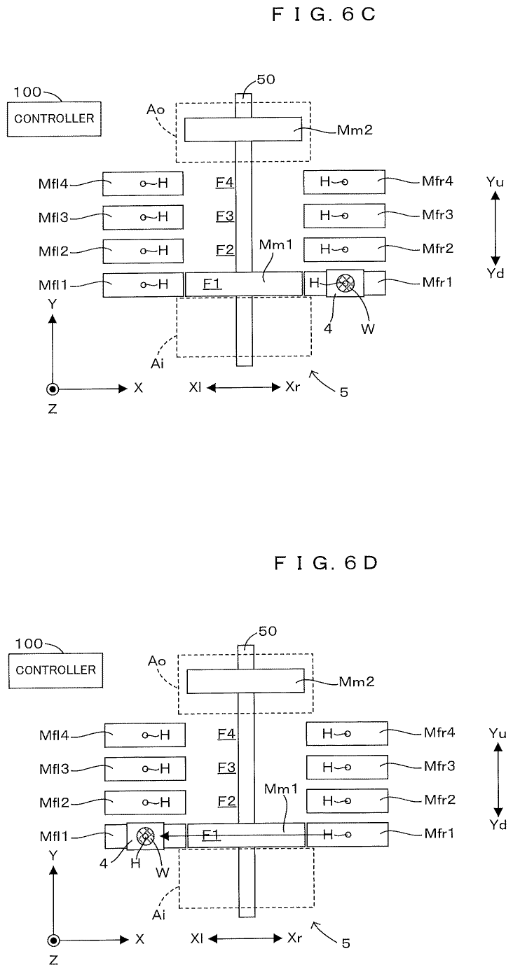

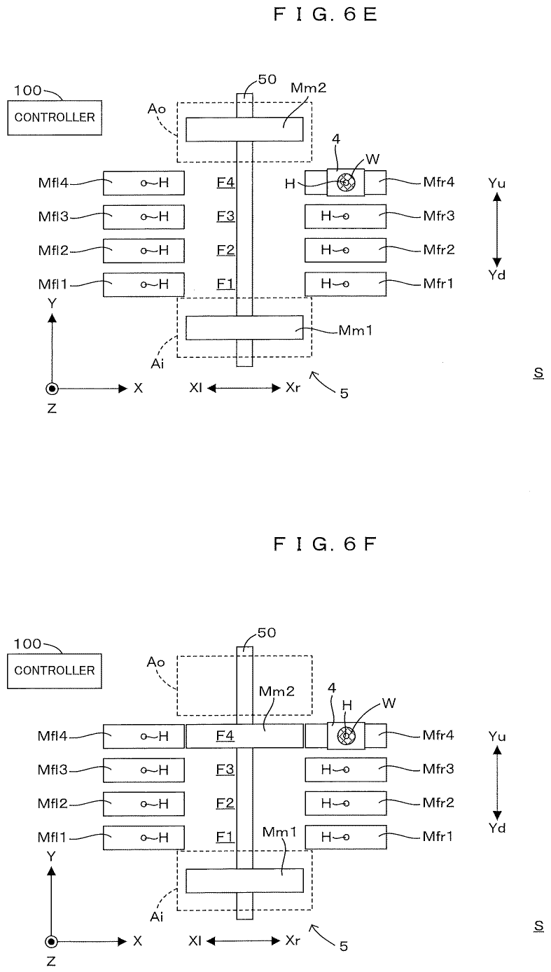

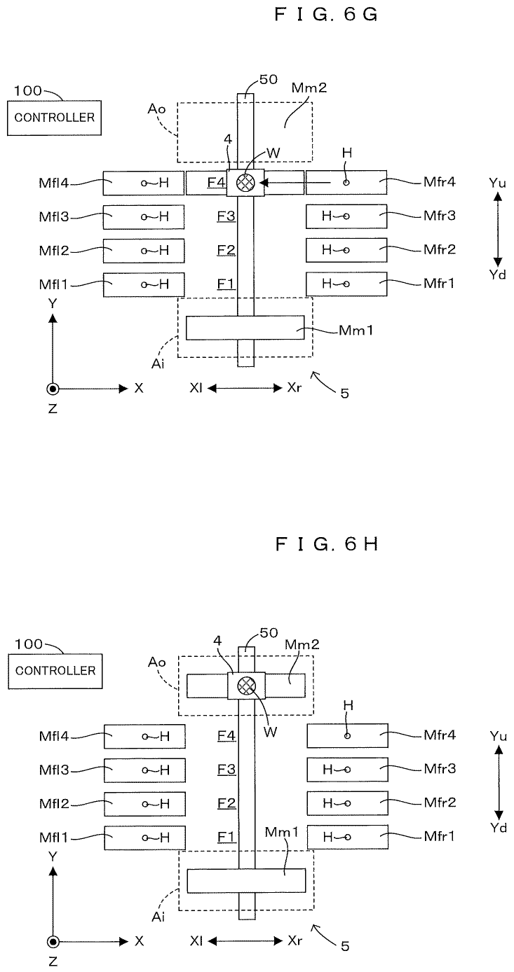

FIGS. 6A to 6H schematically show a fourth example of the conveyor table transport system according to the present disclosure. In the transport system S according to the fourth example, an introduction area Ai is provided at an end of the branch transport device 5 on the Yd side and an ejection area Ao is provided at an end of the branch transport device 5 on the Yu side. Specifically, in the Y direction, the introduction area Ai is positioned on the Yd side relative to the ejection area Ao and the ejection area Ao is positioned on the Yu side relative to the introduction area Ai. In the introduction area Ai, a worker or a robot places a workpiece W on the conveyor table 4 engaged with the movable linear conveyor Mm1 positioned in the introduction area Ai (introduction of the workpiece W). Meanwhile, in the ejection area Ao, a worker or a robot removes the workpiece W from the conveyor table 4 engaged with the movable linear conveyor Mm2 positioned in the ejection area Ao (ejection of the workpiece W).

A plurality of (eight) fixed linear conveyors Mfr1 to Mfr4, Mf11 to Mf14 is arranged between the introduction area Ai and the ejection area Ao in the Y direction. Specifically, the four fixed linear conveyors Mfr1 to Mfr4 are aligned in the Y direction on the Xr side relative to the branch transport device 5, and the four fixed linear conveyors Mf11 to Mf14 are aligned in the Y direction on the Xl side relative to the branch transport device 5. Furthermore, in the X direction, the fixed linear conveyor Mfr1 and the fixed linear conveyor Mf11 face each other at an interval therebetween, and a facing position F1 is provided that faces the fixed linear conveyor Mfr1 from the Xl side and faces the fixed linear conveyor Mf11 from the Xr side. Likewise, in the X direction, the fixed linear conveyors Mfr2 to Mfr4 face the fixed linear conveyors Mf12 to Mf14 at an interval therebetween. Provided are facing positions F2 to F4 facing the fixed linear conveyors Mfr2 to Mfr4 from the Xl side and facing the fixed linear conveyors Mf12 to Mf14 from the Xr side. A working head H faces each of the fixed linear conveyors Mfr1 to Mfr4, Mf11 to Mf14 from above. The working head H conducts predetermined work on a workpiece W placed on the conveyor table 4 held by the fixed linear conveyors Mfr1 to Mfr4, Mf11 to Mf14.

As described above, the branch transport device 5 drives the movable linear conveyor Mm1 in the Y direction by the first drive part 51 and drives the movable linear conveyor Mm2 in the Y direction by the second drive part 52. Thus, the movable linear conveyors Mm1, Mm2 are both movable in the Y direction independently of each other. In particular, the movable linear conveyor Mm1 can be positioned in the introduction area Ai and at the facing positions F1 to F4, and the movable linear conveyor Mm2 can be positioned in the ejection area Ao and at the facing positions F1 to F4. In this transport system S, it is possible to transport the conveyor table 4 by taking a procedure shown in FIGS. 6A to 6I.

In FIG. 6A, the workpiece W is placed on the conveyor table 4 engaged with the movable linear conveyor Mm1 positioned in the introduction area Ai. In FIG. 6B, the movable linear conveyor Mm1 moves from the introduction area Ai to the facing position F1. Then, in FIG. 6C, the conveyor table 4 is transferred from the movable linear conveyor Mm1 at the facing position F1 to the fixed linear conveyor Mfr1. By doing so, it becomes possible for the working head H facing the fixed linear conveyor Mfr1 to conduct work on the workpiece W placed on the conveyor table 4. When the work on the workpiece W at the fixed linear conveyor Mfr1 is completed, the conveyor table 4 is transferred from the fixed linear conveyor Mfr1 to the fixed linear conveyor Mf11 through the movable linear conveyor Mm1 at the facing position F1, as shown in FIG. 6D. By doing so, it becomes possible for the working head H facing the fixed linear conveyor Mf11 to conduct work on the workpiece W placed on the conveyor table 4. In this way, it is possible for the workpiece W introduced in the introduction area Ai to be transported to the fixed linear conveyors Mfr1, Mf11 sequentially, and to conduct work to the workpiece W at each of the fixed linear conveyors Mfr1 and Mf11.

In FIG. 6E, the workpiece W is placed on the conveyor table 4 held by the fixed linear conveyor Mfr4. By doing so, it becomes possible for the working head H facing the fixed linear conveyor Mfr4 to conduct work on the workpiece W placed on the conveyor table 4. In FIG. 6F, the movable linear conveyor Mm2 moves to the facing position F4 to face the fixed linear conveyor Mfr4 from the Xl side. When the work on the workpiece W at the fixed linear conveyor Mfr4 is completed, the conveyor table 4 is transferred from the fixed linear conveyor Mfr4 to the movable linear conveyor Mm2 at the facing position F4, as shown in FIG. 6G. Then, as shown in FIG. 6H, the movable linear conveyor Mm2 moves into the ejection area Ao and the conveyor table 4 held by the movable linear conveyor Mm is transported into the ejection area Ao. Then, the workpiece W is removed from the conveyor table 4 positioned in the ejection area Ao.

In this transport system S, it is possible for the movable linear conveyor Mm1 to move the conveyor table 4 supporting the workpiece W having been introduced into the introduction area Ai to any of the fixed linear conveyors Mfr1 to Mfr4, Mf11 to Mf14. Furthermore, it is possible for the movable linear conveyor Mm1 to move the conveyor table 4 between any ones of the fixed linear conveyors Mfr1 to Mfr4, Mf11 to Mf14. Likewise, it is possible for the movable linear conveyor Mm2 to move the conveyor table 4 between any ones of the fixed linear conveyors Mfr1 to Mfr4, Mf11 to Mf14. Furthermore, it is possible for the movable linear conveyor Mm2 to move the conveyor table 4 from any of the fixed linear conveyors Mfr1 to Mfr4, Mf11 to Mf14 into the ejection area Ao.

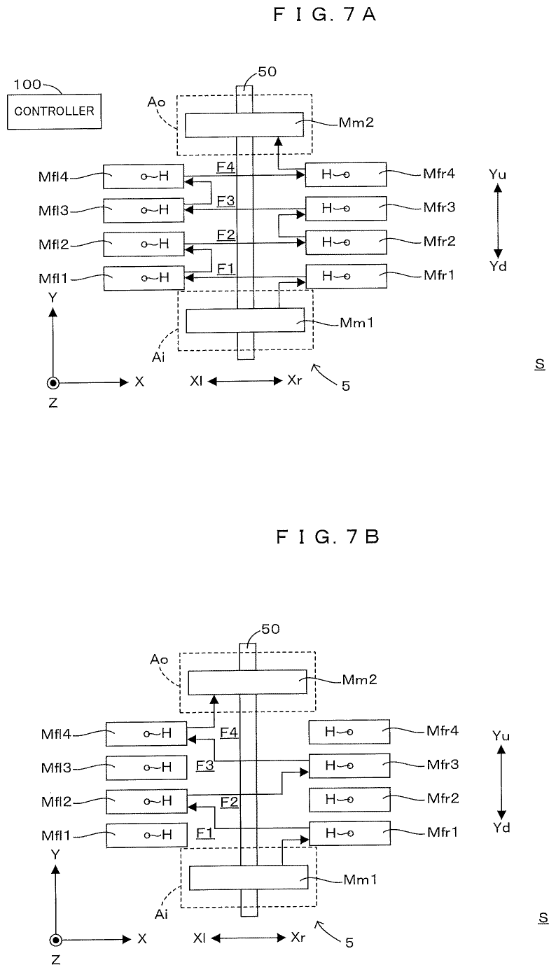

Thus, the transport system S allows the conveyor table 4 to move according to the order shown in FIG. 7A or 7B, for example. FIGS. 7A and 7B schematically show exemplary motions according to the fourth example of the conveyor table transport system.

According to the example in FIG. 7A, the conveyor table 4 in the introduction area Ai moves through the fixed linear conveyors Mfr1, Mf11, Mf12, Mfr2, Mfr3, Mf13, Mf14, Mfr4 in this order and then reaches the ejection area Ao. In this case, the move of the conveyor table 4 from the introduction area Ai is realized by the movable linear conveyor Mm1 and the move of the conveyor table 4 into the ejection area Ao is realized by the movable linear conveyor Mm2. The move of the conveyor table 4 between any ones of the fixed linear conveyors Mfr1, Mf11, Mf12, Mfr2, Mfr3, Mf13, Mf14, Mfr4 may be realized either by the movable linear conveyor Mm1, Mm2.

According to the example in FIG. 7A, the conveyor table 4 in the introduction area Ai moves through the fixed linear conveyors Mfr1, Mf12, Mfr3, Mf14 in this order and then reaches the ejection area Ao. In this case, the move of the conveyor table 4 from the introduction area Ai is realized by the movable linear conveyor Mm1 and the move of the conveyor table 4 into the ejection area Ao is realized by the movable linear conveyor Mm2. The move of the conveyor table 4 between any ones of the fixed linear conveyors Mfr1, Mf12, Mfr3, Mf14 may be realized either by the movable linear conveyor Mm1, Mm2.

As described above, according to the fourth example of the transport system S shown in FIGS. 6A to 6H, FIGS. 7A and 7B, provided are the fixed linear conveyors Mfr1 to Mfr4, Mf11 to Mf14 (work linear conveyor) facing the facing positions F1 to F4 (work facing position) in the X direction (transport direction) between the introduction area Ai (workpiece introduction position) and the ejection area Ao (workpiece ejection position) provided at an interval therebetween in the Y direction (drive direction). The movable linear conveyor Mm1 is positioned on the introduction area Ai side, rather than the movable linear conveyor Mm2, in the Y direction. The movable linear conveyor Mm2 is positioned on the ejection area Ao side, rather than the movable linear conveyor Mm1, in the Y direction. When the first drive part 51 positions the movable linear conveyor Mm1 in the introduction area Ai, the workpiece W is placed on the conveyor table 4 held by the movable linear conveyor Mm1 (FIG. 6A). When the first drive part 51 positions the movable linear conveyor Mm1, which holds the conveyor table 4 with the workpiece W placed thereon, at the facing position F1 (work facing position), the conveyor table 4 is transferred from the movable linear conveyor Mm1 to the fixed linear conveyor Mfr1 (FIGS. 6B to 6C). When the second drive part 52 positions the movable linear conveyor Mm2 at the facing position F4, the conveyor table 4 on which the workpiece W is placed is transferred from the fixed linear conveyor Mfr4 to the movable linear conveyor Mm2. When the second drive part 52 positions the movable linear conveyor Mm2 in the ejection area Ao, the workpiece W is removed from the conveyor table 4 held by the movable linear conveyor Mm2. In this configuration, introduction of the workpiece W is conducted for the movable linear conveyor Mm1 and ejection of the workpiece W is conducted for the movable linear conveyor Mm2. In this way, of the movable linear conveyors Mm1, Mm2 movable in the Y direction independently of each other, the movable linear conveyor Mm1 is used for introduction of the workpiece W and the movable linear conveyor Mm2 is used for ejection of the workpiece W. This allows introduction and ejection of the workpiece W to be conducted independently of each other.

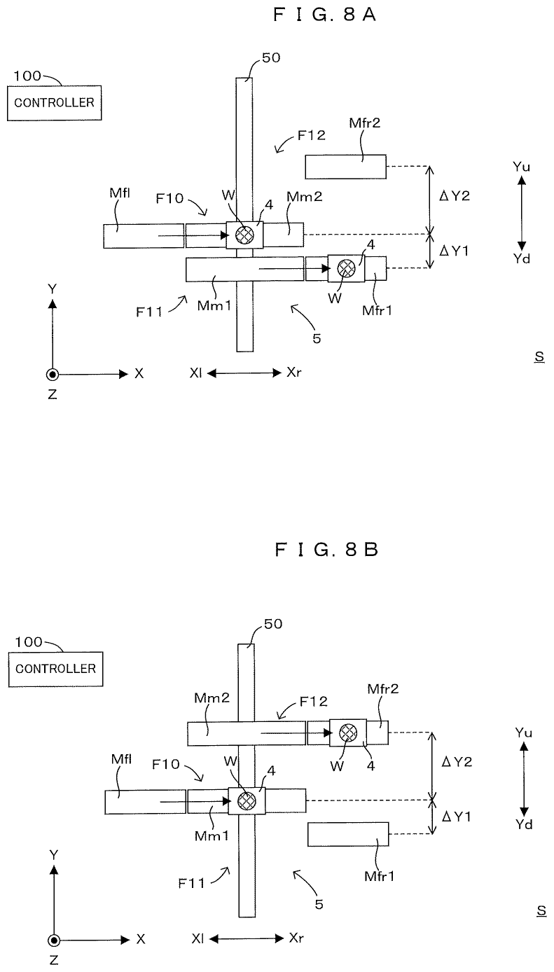

FIGS. 8A and 8B schematically show a fifth example of the conveyor table transport system according to the present disclosure. In the transport system S according to the fifth example, a fixed linear conveyor Mf1 is arranged on the Xl side relative to the branch transport device 5, and two fixed linear conveyors Mfr1 and Mfr2 are aligned in parallel on the Xr side relative to the branch transport device 5. A facing position F10, a facing position F11, and a facing position F12 are provided. In the X direction, the facing position F10 faces the fixed linear conveyor Mf1 from the Xr side, the facing position F11 faces the fixed linear conveyor Mfr1 from the Xl side, and the facing position F12 faces the fixed linear conveyor Mfr2 from the Xl side. In the Y direction, the fixed linear conveyor Mfr1 is arranged on the Yd side relative to the fixed linear conveyor Mf1, the fixed linear conveyor Mfr2 is arranged on the Yu side relative to the fixed linear conveyor Mf1, the facing position F11 is arranged on the Yd side relative to the facing position F10, and the facing position F12 is arranged on the Yu side relative to the facing position F10.

In the Y direction, an interval ΔY1 between the facing position F10 and the facing position F11 and an interval ΔY2 between the facing position F10 and the facing position F12 differ from each other. In FIGS. 8A and 8B, a starting point of each of the intervals ΔY1, ΔY2 is defined by a midpoint of the width in the Y direction (in other words, a midpoint between opposite ends in the Y direction) of the movable linear conveyor Mm1, Mm2 positioned at the facing position F10, F11, F12.

As described above, the branch transport device 5 drives the movable linear conveyor Mm1 in the Y direction by the first drive part 51 and drives the movable linear conveyor Mm2 in the Y direction by the second drive part 52. Thus, the movable linear conveyors Mm1, Mm2 are both movable in the Y direction independently of each other. In particular, the movable linear conveyor Mm1 is movable in the Y direction in a range covering at least the facing position F11 and the facing position F10, and the movable linear conveyor mm2 is movable in the Y direction in a range covering at least the facing position F12 and the facing position F10.

In FIG. 8A, while the movable linear conveyor Mm2 is positioned at the facing position F10 and faces the fixed linear conveyor Mf1 from the Xr side, the movable linear conveyor Mm1 is positioned at the facing position F11 and faces the fixed linear conveyor Mfr1 from the Xl side. In this state, transfer of the conveyor table 4 from the fixed linear conveyor Mf1 to the movable linear conveyor Mm2 at the facing position F10 and transfer of the conveyor table 4 from the movable linear conveyor Mm1 at the facing position F11 to the fixed linear conveyor Mfr1 are conducted in parallel.

In FIG. 8B, while the movable linear conveyor Mm1 is positioned at the facing position F10 and faces the fixed linear conveyor Mf1 from the Xr side, the movable linear conveyor Mm2 is positioned at the facing position F12 and faces the fixed linear conveyor Mfr2 from the Xl side. In this state, transfer of the conveyor table from the fixed linear conveyor Mf1 to the movable linear conveyor Mm1 at the facing position F10 and transfer of the conveyor table 4 from the movable linear conveyor Mm2 at the facing position F12 to the fixed linear conveyor Mfr2 in parallel.

Former transfer and latter transfer are conducted in parallel means that a period in which the former transfer is conducted and a period in which the latter transfer is conducted overlap each other at least partially. The period in which the transfer is conducted means a period from when the conveyor table 4 positioned at a source of the transfer (specifically, a linear conveyor as a source of the transfer) starts to move to when this conveyor table 4 positioned at a destination of the transfer (specifically, a linear conveyor as a destination of the transfer) stops.

As described above, according to the fifth example of the transport system S shown in FIGS. 8A to 8B, provided are the fixed linear conveyor Mf1 (upstream linear conveyor) arranged on an upstream side (Xl side) in the X direction (transport direction) from the branch transport device 5, and the fixed linear conveyor Mfr1 (first downstream linear conveyor) and the fixed linear conveyor Mfr2 (second downstream linear conveyor) aligned in parallel on a downstream side (Xr side) in the X direction from the branch transport device 5. The fixed linear conveyor Mfr1 is positioned on the Yd side (first side) in the Y direction (drive direction) relative to the fixed linear conveyor Mfr2, and the fixed linear conveyor Mfr2 is positioned on the Yu side (second side) in the Y direction relative to the fixed linear conveyor Mfr1. The movable linear conveyor Mm1 is positioned on the Yd side in the Y direction relative to the movable linear conveyor Mm2, and the movable linear conveyor Mm2 is positioned on the Yu side in the Y direction relative to the movable linear conveyor Mm1.

Meanwhile, the first drive part 51 moves the movable linear conveyor Mm1 between the facing position F10 (upstream facing position) facing the fixed linear conveyor Mf1 from the Xr side in the X direction and the facing position F11 (first downstream facing position) facing the fixed linear conveyor Mfr1 from the Xl side in the X direction. The conveyor table 4 is transferred from the fixed linear conveyor Mf1 to the movable linear conveyor Mm1 at the facing position F10 (FIG. 8B). The conveyor table 4 is transferred from the movable linear conveyor Mm1 at the facing position F11 to the fixed linear conveyor Mfr1 (FIG. 8A).

The second drive part 52 moves the movable linear conveyor Mm2 between the facing position F10 and the facing position F12 (second downstream facing position) facing the fixed linear conveyor Mfr2 from the Xl side in the X direction. The conveyor table 4 is transferred from the fixed linear conveyor Mf1 to the movable linear conveyor Mm2 at the facing position F10 (FIG. 8A). The conveyor table 4 is transferred from the movable linear conveyor Mm2 at the facing position F12 to the fixed linear conveyor Mfr2 (FIG. 8B).

In the Y direction, the interval ΔY1 between the facing position F11 and the facing position F10 and the interval ΔY2 between the facing position F12 and the facing position F10 differ from each other. In this configuration, by utilizing the advantage that the movable linear conveyor Mm1 and the movable linear conveyor Mm2 are movable in the Y direction independently of each other, arranged are the fixed linear conveyor Mfr1, which is a destination of transport of the conveyor table 4 by the movable linear conveyor Mm1, and the fixed linear conveyor Mfr2, which is a destination of transport of the conveyor table 4 by the movable linear conveyor Mm2. Specifically, it is possible to locate each of the fixed linear conveyors Mfr1, Mfr2 freely as a destination of transport of the conveyor table 4 in response to an environment of installation of the transport system S.

Transfer of the conveyor table 4 from the fixed linear conveyor Mf1 to the movable linear conveyor Mm1 and transfer of the conveyor table 4 from the movable linear conveyor Mm2 to the fixed linear conveyor Mfr2 are conducted in parallel (FIG. 8B). Furthermore, transfer of the conveyor table 4 from the fixed linear conveyor Mf1 to the movable linear conveyor Mm2 and transfer of the conveyor table 4 from the movable linear conveyor Mm1 to the fixed linear conveyor Mfr1 are conducted in parallel (FIG. 8A). In this way, the motions for branch transport conducted by the movable linear conveyors Mm1, Mm2 are conducted in parallel. This achieves efficient branch transport of the conveyor table 4.

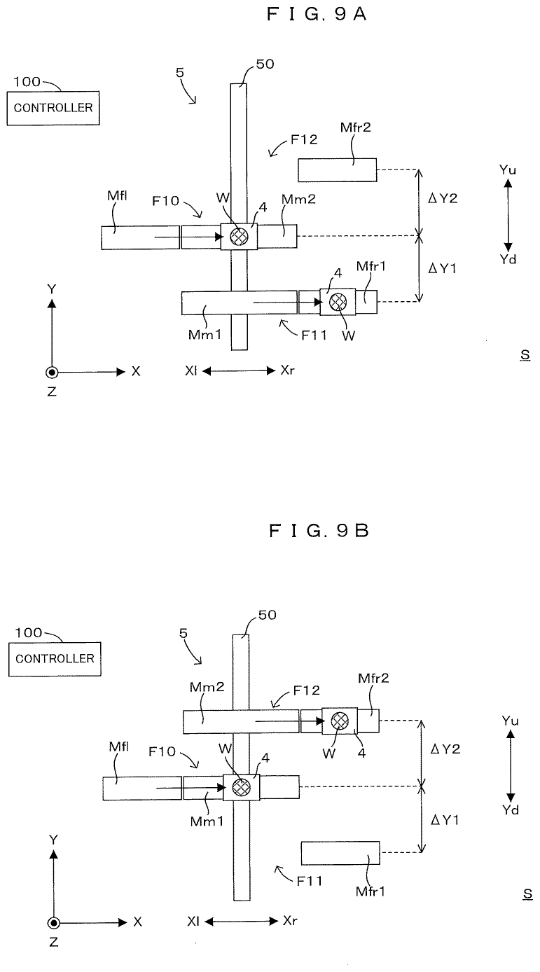

FIGS. 9A to 9B schematically show a sixth example of the conveyor table transport system according to the present disclosure. The sixth example differs from the fifth example in FIGS. 8A and 8B in that the interval ΔY1 between the facing position F11 and the facing position F10 and the interval ΔY2 between the facing position F12 and the facing position F10 are equal to each other. In this case, it is possible to constantly fix an interval in the Y direction between the movable linear conveyor Mm1 and the movable linear conveyor Mm2 (=ΔY1=ΔY2). Thus, the branch transport device 5 is not required to be capable of driving the movable linear conveyor Mm1 and the movable linear conveyor Mm2 in the Y direction independently of each other. For this reason, the branch transport device 5 may drive the movable linear conveyor Mm1 and the movable linear conveyor Mm2 integrally in the Y direction.

Specifically, according to the sixth example of the transport system S shown in FIGS. 9A and 9B, provided is the branch transport device 5 that includes the movable linear conveyor Mm1 (first movable linear conveyor) and the movable linear conveyor Mm2 (second movable linear conveyor) aligned in parallel in the X direction (transport direction), and drives the movable linear conveyors Mm1, Mm2 in the Y direction (drive direction). Provided are a fixed linear conveyor Mf1 (upstream linear conveyor) arranged on an upstream side (Xl side) in the X direction from the branch transport device 5, and a fixed linear conveyor Mfr1 (first downstream linear conveyor) and a fixed linear conveyor Mfr2 (second downstream linear conveyor) aligned in parallel on a downstream side in the X direction from the branch transport device 5. The fixed linear conveyor Mfr1 is positioned on the Yd side (first side) in the Y direction relative to the fixed linear conveyor Mfr2, and the fixed linear conveyor Mfr2 is positioned on the Yu side (second side) in the Y direction relative to the fixed linear conveyor Mfr1. The movable linear conveyor Mm1 is positioned on the Yd side in the Y direction relative to the movable linear conveyor Mm2, and the movable linear conveyor Mm2 is positioned on the Yu side in the Y direction relative to the movable linear conveyor Mm1.

Meanwhile, while causing the movable linear conveyor Mm1 to face the fixed linear conveyor Mf1 in the X direction and causing the movable linear conveyor Mm2 to face the fixed linear conveyor Mfr2 in the X direction, the branch transport device 5 conducts transfer of the conveyor table 4 from the fixed linear conveyor Mf1 to the movable linear conveyor Mm1 and transfer of the conveyor table 4 from the movable linear conveyor Mm2 to the fixed linear conveyor Mfr2 in parallel (FIG. 9B). Furthermore, while causing the movable linear conveyor Mm2 to face the fixed linear conveyor Mf1 in the X direction and causing the movable linear conveyor Mm1 to face the fixed linear conveyor Mfr1 in the X direction, the branch transport device 5 conducts transfer of the conveyor table 4 from the fixed linear conveyor Mf1 to the movable linear conveyor Mm2 and transfer of the conveyor table 4 from the movable linear conveyor Mm1 to the fixed linear conveyor Mfr1 in parallel (FIG. 9A).

Specifically, transfer of the conveyor table 4 from the fixed linear conveyor Mf1 to the movable linear conveyor Mm1 and transfer of the conveyor table 4 from the movable linear conveyor Mm2 to the fixed linear conveyor Mfr2 are conducted in parallel (FIG. 9B). Furthermore, transfer of the conveyor table 4 from the fixed linear conveyor Mf1 to the movable linear conveyor Mm2 and transfer of the conveyor table 4 from the movable linear conveyor Mm1 to the fixed linear conveyor Mfr1 are conducted in parallel (FIG. 9A). In this way, the motions for branch transport conducted by the movable linear conveyors Mm1, Mm2 are conducted in parallel. This achieves efficient branch transport of the conveyor table 4.

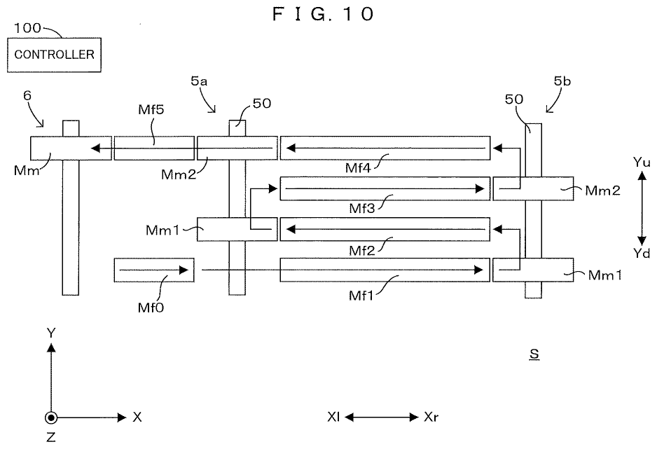

FIG. 10 schematically shows a seventh example of the conveyor table transport system according to the present disclosure. In the transport system S according to the seventh example, two branch transport devices 5a and 5b are arranged at an interval therebetween in the X direction. In the X direction, the branch transport device 5a is arranged on the Xl side relative to the branch transport device 5b, and the branch transport device 5b is arranged on the Xr side relative to the branch transport device 5a. A plurality of (four) fixed linear conveyors Mf1 to Mf4 are aligned in parallel between the branch transport device 5a and the branch transport device 5b in the X direction.

Thus, while the branch transport device 5a causes the movable linear conveyor Mm1 to face the fixed linear conveyor Mf1 in the X direction, it is possible to transfer the conveyor table 4 between the movable linear conveyor Mm1 and the fixed linear conveyor Mf1. The conveyor table 4 is transferred in the same way between the different fixed linear conveyor Mf2, Mf3 and the movable linear conveyor Mm1.

While the branch transport device 5a causes the movable linear conveyor Mm2 to face the fixed linear conveyor Mf4 in the X direction, it is possible to transfer the conveyor table 4 between the movable linear conveyor Mm2 and the fixed linear conveyor Mf4. The conveyor table 4 is transferred in the same way between the different fixed linear conveyor Mf2, Mf3 and the movable linear conveyor Mm2.

While the branch transport device 5b causes the movable linear conveyor Mm1 to face the fixed linear conveyor Mf1 in the X direction, it is possible to transfer the conveyor table 4 between the movable linear conveyor Mm1 and the fixed linear conveyor Mf1. The conveyor table 4 is transferred in the same way between the different fixed linear conveyor Mf2, Mf3 and the movable linear conveyor Mm1.

While the branch transport device 5b causes the movable linear conveyor Mm2 to face the fixed linear conveyor Mf4 in the X direction, it is possible to transfer the conveyor table 4 between the movable linear conveyor Mm2 and the fixed linear conveyor Mf4. The conveyor table 4 is transferred in the same way between the different fixed linear conveyor Mf2, Mf3 and the movable linear conveyor Mm2.

The transport system S includes a fixed linear conveyor Mf0 and a fixed linear conveyor Mf5 arranged on the Xl side relative to the branch transport device 5a. The fixed linear conveyor Mf0 and the fixed linear conveyor Mf1 are aligned in series at an interval therebetween in the X direction. The fixed linear conveyor Mf5 and the fixed linear conveyor Mf4 are aligned in series at an interval therebetween in the X direction.

The transport system S further includes a circulation transport device 6 arranged on the Xl side relative to the fixed linear conveyors Mf0 and Mf5 in the X direction. The circulation transport device 6 includes a movable linear conveyor Mm and drives the movable linear conveyor Mm in the Y direction. While the movable linear conveyor Mm of the circulation transport device 6 faces the fixed linear conveyor Mf5 in the X direction, the conveyor table 4 is transferred between the movable linear conveyor Mm of the circulation transport device 6 and the fixed linear conveyor Mf5. Furthermore, while the movable linear conveyor Mm of the circulation transport device 6 faces the fixed linear conveyor Mf0 in the X direction, the conveyor table 4 is transferred between the movable linear conveyor Mm of the circulation transport device 6 and the fixed linear conveyor Mf0.

In this transport system S, it is possible to transport the conveyor table 4 according to the order represented by arrows in FIG. 10, for example. Specifically, the movable linear conveyor Mm1 of the branch transport device 5a transfers the conveyor table 4 having been received from the fixed linear conveyor Mf0 to the fixed linear conveyor Mf1. The movable linear conveyor Mm1 of the branch transport device 5b transfers the conveyor table 4 having been received from the fixed linear conveyor Mf1 to the fixed linear conveyor Mf2. The movable linear conveyor Mm1 or the movable linear conveyor Mm2 of the branch transport device 5a transfers the conveyor table 4 having been received from the fixed linear conveyor Mf2 to the fixed linear conveyor Mf3. The movable linear conveyor Mm2 of the branch transport device 5b transfers the conveyor table 4 having been received from the fixed linear conveyor Mf3 to the fixed linear conveyor Mf4. The movable linear conveyor Mm2 of the branch transport device 5a transfers the conveyor table 4 having been received from the fixed linear conveyor Mf4 to the fixed linear conveyor Mf5. The movable linear conveyor Mm of the circulation transport device 6 transfers the conveyor table 4 having been received from the fixed linear conveyor Mf5 to the fixed linear conveyor Mf0. In this way, the conveyor table 4 is driven in circulation.

As described above, according to the seventh example of the transport system S shown in FIG. 10, provided are the branch transport device 5a (first branch transport device) and the branch transport device 5b (second branch transport device) arranged at an interval therebetween in the X direction (transport direction), and a plurality of the fixed linear conveyors Mf1 to Mf4 aligned in parallel in the X direction between the branch transport device 5a and the branch transport device 5b. The branch transport devices 5a, 5b each have the configuration same as that of the branch transport device 5 shown in FIG. 2A or 2B.

The conveyor table 4 is transferred between any of the fixed linear conveyors Mf1 to Mf3 facing the movable linear conveyor Mm1 of the branch transport device 5a and this movable linear conveyor Mm1, and the branch transport device 5a drives the movable linear conveyor Mm1 in the Y direction by the first drive part 51, thereby switching between the fixed linear conveyors Mf1 to Mf3 to face the movable linear conveyor Mm1. The conveyor table 4 is transferred between any of the fixed linear conveyors Mf2 to mF4 facing the movable linear conveyor Mm2 of the branch transport device 5a and this movable linear conveyor Mm2, and the branch transport device 5a drives the movable linear conveyor Mm2 in the Y direction by the second drive part 52, thereby switching between the fixed linear conveyors Mf2 to Mf4 to face the movable linear conveyor Mm2. The branch transport device 5b is capable of transferring the conveyor table 4 in the same way to and from the fixed linear conveyors Mf1 to Mf4 by the movable linear conveyors Mm1, Mm2.

In this configuration, it is possible to transport the conveyor table 4 by moving the movable linear conveyors Mm1, Mm2 of each of the branch transport devices 5a, 5b independently of each other in the Y direction on the opposite sides of the plurality of fixed linear conveyors Mf1 to Mf4 arranged in parallel in the X direction.

As described above, in the foregoing embodiment, the transport system S corresponds to an example of a “conveyor table transport system” of the present disclosure, the branch transport device 5 corresponds to an example of a “branch transport device” of the present disclosure, the drive mechanism 50 corresponds to an example of a “drive mechanism” of the present disclosure, the first drive part 51 corresponds to an example of a “first drive part” of the present disclosure, the second drive part 52 corresponds to an example of a “second drive part” of the present disclosure, the movable linear conveyor Mm1 corresponds to an example of a “first movable linear conveyor” of the present disclosure, the movable linear conveyor Mm2 corresponds to an example of a “second movable linear conveyor” of the present disclosure, the X direction corresponds to an example of a “transport direction” of the present disclosure, and the Y direction corresponds to an example of a “drive direction” of the present disclosure.

The present disclosure is not limited to the above-described embodiment but various changes can be added to the substance described above unless such changes deviate from the purport of the disclosure. For example, the transport direction of the conveyor table 4 and the drive direction of each of the movable linear conveyors Mm1, Mm2 are not required to be orthogonal to each other but may slant toward each other.

What is claimed is:

1. A branch transport device comprising:
a first movable linear conveyor and a second movable linear conveyor aligned in parallel in a predetermined transport direction; and
a drive mechanism including a first drive part configured to drive the first movable linear conveyor in a drive direction different from the transport direction and a second drive part configured to drive the second movable linear conveyor in the drive direction, wherein
each of the first movable linear conveyor and the second movable linear conveyor is configured to transport a conveyor table in the transport direction.

2. The branch transport device according to claim 1, wherein
the first drive part is mounted on the first movable linear conveyor and is configured to drive the first movable linear conveyor in the drive direction by moving in the drive direction, and
the second drive part is mounted on the second movable linear conveyor and is configured to drive the second movable linear conveyor in the drive direction by moving in the drive direction.

3. The branch transport device according to claim 2, wherein
the drive mechanism further includes a screw shaft parallel to the drive direction,
the first drive part includes a first nut threadedly engaged with the screw shaft and a first motor configured to drive the first nut, and is configured to move in the drive direction by rotating the first nut relative to the screw shaft by the first motor, and
the second drive part includes a second nut threadedly engaged with the screw shaft and a second motor to drive the second nut, and is configured to move in the drive direction by rotating the second nut relative to the screw shaft by the second motor.

4. The branch transport device according to claim 2, wherein
the drive mechanism further includes a stator formed including a permanent magnet parallel to the drive direction,
the first drive part includes a first mover formed including a coil and configured to move in the drive direction in response to magnetic force generated between the first mover and the stator, and
the second drive part includes a second mover formed including a coil and configured to move in the drive direction in response to magnetic force generated between the second mover and the stator.

5. The branch transport device according to claim 1, wherein
the transport direction and the drive direction are orthogonal to each other.

6. A conveyor table transport system comprising:
the branch transport device according to any claim 1; and
a line linear conveyor, wherein
the first movable linear conveyor is on a first side in the drive direction relative to the second movable linear conveyor,
the second movable linear conveyor is on a second side opposite the first side in the drive direction relative to the first movable linear conveyor,
while the first drive part positions the first movable linear conveyor at a transport facing position facing the line linear conveyor in the transport direction, a first conveyor table is transferred between the first movable linear conveyor and the line linear conveyor, and
while the second drive part positions the second movable linear conveyor at the transport facing position, a second conveyor table is transferred between the second movable linear conveyor and the line linear conveyor.

7. The conveyor table transport system according to claim 6, further comprising:
a first working unit in a first work area on the first side in the drive direction relative to the transport facing position, wherein
in the first work area, first work is conducted on a first workpiece supported by the first conveyor table,
the first drive part is configured to move the first movable linear conveyor holding the first conveyor table to the first work area, and
in the first work area, the first drive part is configured to move the first movable linear conveyor in the drive direction and the first movable linear conveyor is configure to move the first conveyor table in the transport direction, thereby causing the first working unit, the first drive part, and the first movable linear conveyor to conduct the first work in cooperation with each other.

8. The conveyor table transport system according to claim 7, further comprising:
a second working unit in a second work area on the second side in the drive direction relative to the transport facing position, wherein
in the second work area, second work is conducted on a second workpiece supported by the second conveyor table,
the second drive part is configured to move the second movable linear conveyor holding the second conveyor table to the second work area, and
in the second work area, the second drive part is configured to move the second movable linear conveyor in the drive direction and the second movable linear conveyor is configured to move the second conveyor table in the transport direction, thereby causing the second working unit, the second drive part, and the second movable linear conveyor to conduct the second work in cooperation with each other.

9. The conveyor table transport system according to claim 8, wherein
a period when the first work is conducted and a period when the second work is conducted overlap each other at least partially.

10. The conveyor table transport system according to claim 6, further comprising:
a first work linear conveyor facing a first work facing position arranged on the first side in the drive direction relative to the transport facing position, in the transport direction, wherein
the first drive part is configured to move the first movable linear conveyor holding the first conveyor table to the first work facing position,
the first conveyor table is configured to transfer from the first movable linear conveyor positioned at the first work facing position to the first work linear conveyor, and
first work is conducted on a first workpiece supported by the first conveyor table held by the first work linear conveyor.

11. The conveyor table transport system according to claim 10, further comprising:
a second work linear conveyor facing a second work facing position arranged on the second side in the drive direction relative to the transport facing position, in the transport direction, wherein
the second drive part is configured to move the second movable linear conveyor holding the second conveyor table to the second work facing position,
the second conveyor table is configured to transfer from the second movable linear conveyor positioned at the second work facing position to the second work linear conveyor, and
second work is conducted on a second workpiece supported by the second conveyor table held by the second work linear conveyor.

12. The conveyor table transport system according to claim 11, wherein
a period when the first work is conducted and a period when the second work is conducted overlap each other at least partially.

13. A conveyor table transport system comprising:
the branch transport device according to claim 1; and
a work linear conveyor facing a work facing position between a workpiece introduction position and a workpiece ejection position arranged at an interval therebetween in the drive direction, in the transport direction, wherein
the first movable linear conveyor is positioned on the workpiece introduction position side rather than the second movable linear conveyor in the drive direction,
the second movable linear conveyor is positioned on the workpiece ejection position side rather than the first movable linear conveyor in the drive direction,
when the first drive part positions the first movable linear conveyor at the workpiece introduction position, a workpiece is placed on one conveyor table held by the first movable linear conveyor,
when the first drive part positions the first movable linear conveyor holding the one conveyor table on which the workpiece is placed, at the work facing position, the one conveyor table is transferred from the first movable linear conveyor to the work linear conveyor,
when the second drive part is configured to position the second movable linear conveyor at the work facing position, the one conveyor table on which the workpiece is placed is transferred from the work linear conveyor to the second movable linear conveyor, and
when the second drive part is configured to position the second movable linear conveyor at the workpiece ejection position, the workpiece is removed from the one conveyor table.

14. A conveyor table transport system comprising:
the branch transport device according to claim 1;
an upstream linear conveyor on an upstream side in the transport direction from the branch transport device; and
a first downstream linear conveyor and a second downstream linear conveyor aligned in parallel on a downstream side in the transport direction from the branch transport device, wherein
the first downstream linear conveyor is positioned on a first side in the drive direction relative to the second downstream linear conveyor,
the second downstream linear conveyor is positioned on a second side in the drive direction relative to the first downstream linear conveyor,
the first movable linear conveyor is positioned on the first side in the drive direction relative to the second movable linear conveyor,
the second movable linear conveyor is positioned on the second side opposite the first side in the drive direction relative to the first movable linear conveyor,
the first drive part is configured to move the first movable linear conveyor between an upstream facing position facing the upstream linear conveyor from the downstream side in the transport direction and a first downstream facing position facing the first downstream linear conveyor from the upstream side in the transport direction,
the conveyor table is configured to transfer from the upstream linear conveyor to the first movable linear conveyor positioned at the upstream facing position,
the conveyor table is configured to transfer from the first movable linear conveyor positioned at the first downstream facing position to the first downstream linear conveyor,
the second drive part is configured to move the second movable linear conveyor between the upstream facing position and a second downstream facing position facing the second downstream linear conveyor from the upstream side in the transport direction,
the conveyor table is configured to transfer from the upstream linear conveyor to the second movable linear conveyor positioned at the upstream facing position,
the conveyor table is configured to transfer from the second movable linear conveyor positioned at the second downstream facing position to the second downstream linear conveyor, and
in the drive direction, an interval between the first downstream facing position and the upstream facing position and an interval between the second downstream facing position and the upstream facing position differ from each other.

15. A conveyor table transport system comprising:
a first branch transport device and a second branch transport device arranged at an interval therebetween in the transport direction; and
a plurality of work linear conveyors aligned in parallel in the transport direction between the first branch transport device and the second branch transport device, wherein
the first branch transport device and the second branch transport device each have a configuration same as that of the branch transport device according to claim 1,
the conveyor table is configured to transfer between the work linear conveyor facing the first movable linear conveyor of the first branch transport device and the first movable linear conveyor, and the first branch transport device is configured to drive the first movable linear conveyor in the drive direction by the first drive part, thereby switching the work linear conveyor to face the first movable linear conveyor,
the conveyor table is configured to transfer between the work linear conveyor facing the second movable linear conveyor of the first branch transport device and the second movable linear conveyor, and the first branch transport device is configured to drive the second movable linear conveyor in the drive direction by the second drive part, thereby switching the work linear conveyor to face the second movable linear conveyor,
the conveyor table is configured to transfer between the work linear conveyor facing the first movable linear conveyor of the second branch transport device and the first movable linear conveyor, and the second branch transport device is configured to drive the first movable linear conveyor in the drive direction by the first drive part, thereby switching the work linear conveyor to face the first movable linear conveyor, and
the conveyor table is configured to transfer between the work linear conveyor facing the second movable linear conveyor of the second branch transport device and the second movable linear conveyor, and the second branch transport device is configured to drive the second movable linear conveyor in the drive direction by the second drive part, thereby switching the work linear conveyor to face the second movable linear conveyor.

16. A conveyor table transport method comprising:
driving a first movable linear conveyor of the first movable linear conveyor and a second movable linear conveyor, which are aligned in parallel in a predetermined transport direction and each of which transports a conveyor table in the transport direction, in a drive direction different from the transport direction by a first drive part; and
driving the second movable linear conveyor in the drive direction by the first drive part.

17. A conveyor table transport system comprising:
a branch transport device including a first movable linear conveyor and a second movable linear conveyor aligned in parallel in a predetermined transport direction, and configured to drive the first movable linear conveyor and the second movable linear conveyor in a drive direction different from the transport direction;
an upstream linear conveyor on an upstream side in the transport direction from the branch transport device; and
a first downstream linear conveyor and a second downstream linear conveyor aligned in parallel on a downstream side in the transport direction from the branch transport device, wherein
the first downstream linear conveyor is on a first side in the drive direction relative to the second downstream linear conveyor,
the second downstream linear conveyor is on a second side in the drive direction relative to the first downstream linear conveyor,
the first movable linear conveyor is on the first side in the drive direction relative to the second movable linear conveyor,
the second movable linear conveyor is on the second side opposite the first side in the drive direction relative to the first movable linear conveyor,
while causing the first movable linear conveyor to face the upstream linear conveyor in the transport direction and causing the second movable linear conveyor to face the second downstream linear conveyor in the transport direction, the branch transport device conducts transfer of a conveyor table from the upstream linear conveyor to the first movable linear conveyor and transfer of a conveyor table from the second movable linear conveyor to the second downstream linear conveyor in parallel, and
while causing the second movable linear conveyor to face the upstream linear conveyor in the transport direction and causing the first movable linear conveyor to face the first downstream linear conveyor in the transport direction, the branch transport device conducts transfer of a conveyor table from the upstream linear conveyor to the second movable linear conveyor and transfer of a conveyor table from the first movable linear conveyor to the first downstream linear conveyor in parallel.

18. A conveyor table transport method of transporting a conveyor table using a branch transport device, an upstream linear conveyor, a first downstream linear conveyor and a second downstream linear conveyor, the branch transport device including a first movable linear conveyor and a second movable linear conveyor aligned in parallel in a predetermined transport direction, and driving the first movable linear conveyor and the second movable linear conveyor in a drive direction different from the transport direction, the upstream linear conveyor being arranged on an upstream side in the transport direction from the branch transport device, the first downstream linear conveyor and the second downstream linear conveyor being aligned in parallel on a downstream side in the transport direction from the branch transport device, wherein
the first downstream linear conveyor is on a first side in the drive direction relative to the second downstream linear conveyor,
the second downstream linear conveyor is on a second side in the drive direction relative to the first downstream linear conveyor,
the first movable linear conveyor is on the first side in the drive direction relative to the second movable linear conveyor,
the second movable linear conveyor is on the second side opposite the first side in the drive direction relative to the first movable linear conveyor,
while causing the first movable linear conveyor to face the upstream linear conveyor in the transport direction and causing the second movable linear conveyor to face the second downstream linear conveyor in the transport direction, the branch transport device conducts transfer of a conveyor table from the upstream linear conveyor to the first movable linear conveyor and transfer of a conveyor table from the second movable linear conveyor to the second downstream linear conveyor in parallel, and
while causing the second movable linear conveyor to face the upstream linear conveyor in the transport direction and causing the first movable linear conveyor to face the first downstream linear conveyor in the transport direction, the branch transport device conducts transfer of a conveyor table from the upstream linear conveyor to the second movable linear conveyor and transfer of a conveyor table from the first movable linear conveyor to the first downstream linear conveyor in parallel.

19. A conveyor table transport method comprising:
a step of integrally driving a first movable linear conveyor and a second movable linear conveyor, which are aligned in parallel in a predetermined transport direction and each of which transports a conveyor table in the transport direction, in a drive direction different from the transport direction thereby transporting the first movable linear conveyor to a first work area; and
a step of conducting first work on a workpiece supported by a conveyor table in the first work area while transporting the conveyor table in the transport direction by the first linear conveyor.

20. A conveyor table transport system comprising:
the branch transport device according to claim 2; and
a line linear conveyor, wherein
the first movable linear conveyor is on a first side in the drive direction relative to the second movable linear conveyor,
the second movable linear conveyor is on a second side opposite the first side in the drive direction relative to the first movable linear conveyor,
while the first drive part positions the first movable linear conveyor at a transport facing position facing the line linear conveyor in the transport direction, a first conveyor table is transferred between the first movable linear conveyor and the line linear conveyor, and
while the second drive part positions the second movable linear conveyor at the transport facing position, a second conveyor table is transferred between the second movable linear conveyor and the line linear conveyor.
